(19) United States
(12) Patent Application Publication
(10) Pub. No.: US 2025/0224722 A1
(43) Pub. Date: Jul. 10, 2025

(54) PLANT DIAGNOSIS METHOD AND RELATED APPARATUS

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 19/088,995

(22) Filed: Mar. 25, 2025

Related U.S. Application Data
(63) Continuation-in-part of application No. PCT/CN2023/115207, filed on Aug. 28, 2023.

(30) Foreign Application Priority Data
Sep. 27, 2022 (CN) 202211180906.7
Feb. 25, 2025 (CN) 202510209803.6

(51) Int. Cl. G05B 23/02

(52) U.S. Cl. CPC G05B 23/0254; G05B 23/0283

(57) ABSTRACT

The present disclosure relates to a plant diagnosis method and related apparatuses. A plant diagnosis method includes: acquiring information related to a plant based on a user input, the information including one or more plant images; inputting the information into a plant diagnosis model, the plant diagnosis model including at least one of a first identification model and a second identification model, the first identification model being configured to acquire growth environment information of the plant based on the information, the second identification model being configured to acquire disease representation information of the plant based on the information, wherein the first identification model and the second identification model are respectively trained using sample-labeled data containing multiple modalities, the multiple modalities including images; and outputting a diagnosis result of the plant determined based on the growth environment information and the disease representation information of the plant through the plant diagnosis model.

### CROSS-REFERENCE TO RELATED APPLICATION

This application is a continuation-in-part application of PCT application serial no. PCT/CN2023/115207 filed on Aug. 28, 2023, which claims the priority benefit of China application no. 202211180906.7 filed on Sep. 27, 2022 and China application no. 202510209803.6 filed on Feb. 25, 2025. The entirety of each of the above-mentioned patent applications is hereby incorporated by reference herein and made a part of this specification.

### BACKGROUND

### Technical Field

The present disclosure relates to the field of information processing technology, and more specifically, relates to a plant diagnosis method and apparatus, an electronic device, a non-transitory storage medium and a computer program product, and also relates to a maintenance system.

### Description of Related Art

With the improvement of living standards, an increasing number of users have begun to cultivate and maintain plants. However, during the growth process, plants may be subject to various diseases and pathological conditions. This necessitates that users accurately identify and promptly address plant ailments; failure to do so may result in impaired plant development or, in severe cases, plant mortality, thereby diminishing the aesthetic value of the plants and potentially causing economic loss to the users.

### SUMMARY

In the following, a brief overview of the present disclosure is provided to offer a basic understanding of some aspects of the present disclosure. However, it should be understood that this overview is not an exhaustive overview of the present disclosure. It is not intended to identify key or critical parts of the present disclosure, nor is it intended to limit the scope of the present disclosure. Its purpose is merely to present some concepts of the present disclosure in a simplified form as a prelude to the more detailed description given later.

According to the first aspect of the present disclosure, a plant diagnosis method is provided, including: acquiring information related to a plant based on a user input, the information including one or more plant images; inputting the information into a plant diagnosis model, the plant diagnosis model including at least one of a first identification model and a second identification model, the first identification model being configured to acquire growth environment information of the plant based on the information, the second identification model being configured to acquire disease representation information of the plant based on the information, wherein the first identification model and the second identification model are respectively trained using sample-labeled data containing multiple modalities, the multiple modalities including images; and outputting a diagnosis result of the plant determined based on the growth environment information and the disease representation information of the plant through the plant diagnosis model.

According to a second aspect of the present disclosure, an electronic device is provided, including: a processor; and a memory storing computer-executable instructions. The computer-executable instructions, when being executed by the processor, enable the processor to execute the plant diagnosis method according to any embodiment of the first aspect of the present disclosure.

According to a third aspect of the present disclosure, a non-transitory storage medium storing computer-executable instructions is provided. The computer-executable instructions, when being executed by a computer, enable the computer to execute the plant diagnosis method according to any embodiment of the first aspect of the present disclosure.

According to a fourth aspect of the present disclosure, a computer program product is provided. The computer program product includes instructions. The instructions, when being executed by a processor, realize the plant diagnosis method according to any embodiment of the first aspect of the present disclosure.

According to a fifth aspect of the present disclosure, a maintenance system is provided, including: an electronic device. The electronic device includes a processor and a memory coupled to the processor and storing instructions. The instructions, when being executed by the processor, enable the processor to: acquire information related to a plant based on a user input, the information including one or more plant images; input the information to a plant diagnosis model, the plant diagnosis model including at least one of a first identification model and a second identification model, the first identification model being configured to acquire growth environment information of the plant based on the information, the second identification model being configured to acquire disease representation information of the plant based on the information, wherein the first identification model and the second identification model are respectively trained using sample-labeled data containing multiple modalities, the multiple modalities include images; output a diagnosis result of the plant determined based on the growth environment information and disease representation information of the plant through the plant diagnosis model; generate a maintenance plan according to the diagnosis result, the maintenance plan including one or more pairs, each pair of the one or more pairs including one or more maintenance tasks and identification of a maintenance apparatus for executing the one or more maintenance tasks; and transmit commands to a corresponding maintenance apparatus according to the identification of the maintenance apparatus in each pair of the one or more pairs in the maintenance plan to control the corresponding maintenance apparatus to complete the one or more maintenance tasks in the pair. A maintenance apparatus is also included to be communicatively coupled to the electronic device. The maintenance apparatus is configured to execute maintenance tasks in response to receiving the commands from the electronic device.

### BRIEF DESCRIPTION OF THE DRAWINGS

From the following description of embodiments of the present disclosure in conjunction with the accompanying drawings, the aforementioned and other features and advantages of the present disclosure will become clear. The drawings are incorporated herein and form a part of the specification, further serving to explain the principles of the present disclosure and to enable a person skilled in the art to make and use the present disclosure. Wherein:

FIG. 1 shows a flowchart of a plant diagnosis method according to some embodiments of the present disclosure;

FIG. 2 shows a schematic block diagram of a plant diagnosis model according to some embodiments of the present disclosure;

FIG. 3 shows a chain of thought of growth environment information, disease representation information, other information and cause of disease in the plant diagnosis method according to some embodiments of the present disclosure;

FIG. 4 shows a schematic diagram of an example user interface of the plant diagnosis method according to some embodiments of the present disclosure;

FIG. 5 shows a schematic diagram of an example user interface of the plant diagnosis method according to some embodiments of the present disclosure;

FIG. 6 shows a schematic diagram of an example user interface of the plant diagnosis method according to some embodiments of the present disclosure;

FIG. 7 shows a schematic diagram of an example user interface of the plant diagnosis method according to some embodiments of the present disclosure;

FIG. 8 shows a schematic block diagram of an electronic device according to some embodiments of the present disclosure;

FIG. 9 shows a schematic block diagram of a computer system on which embodiments of the present disclosure may be implemented;

FIG. 10 shows a schematic block diagram of a maintenance system according to some embodiments of the present disclosure;

FIG. 11 is a flow diagram of a plant diagnosis method according to some embodiments of the present disclosure;

FIG. 12 is a flow diagram of a plant diagnosis method according to some embodiments of the present disclosure;

FIG. 13 is a structural schematic diagram of a plant diagnosis apparatus according to some embodiments of the present disclosure;

FIG. 14 is a structural schematic diagram of a plant diagnosis apparatus according to some other embodiments of the present disclosure.

Note that in the embodiments described below, the same reference numerals are sometimes used across different drawings to indicate the same parts or parts with the same function, and their repeated descriptions are omitted. In some cases, similar numerals and letters are used to indicate similar items, so once an item is defined in one drawing, no further discussion of it is needed in subsequent drawings.

For ease of understanding, the positions, dimensions, and ranges of various structures shown in the drawings, etc., sometimes do not represent actual positions, dimensions, and ranges. Therefore, the present disclosure is not limited to the positions, dimensions, and ranges disclosed in the drawings, etc.

### DESCRIPTION OF THE EMBODIMENTS

Various exemplary embodiments of the present disclosure will be described in detail with reference to the accompanying drawings. It should be noted that: unless specifically stated otherwise, the relative arrangement of components and steps, numerical expressions and values set forth in these embodiments do not limit the scope of the present disclosure.

The following description of at least one exemplary embodiment is actually merely illustrative and is not intended as any limitation on the present disclosure and its application or use. That is, the structures and methods in this document are shown in an exemplary manner to illustrate different embodiments of the structures and methods in the present disclosure. However, those skilled in the art will understand that they merely illustrate exemplary ways that may be used to implement the present disclosure, rather than exhaustive ways. Furthermore, the drawings need not be drawn to scale, and some features may be enlarged to show details of specific components.

In addition, technologies, methods, and devices known to ordinary skilled persons in the relevant field may not be discussed in detail, but in appropriate circumstances, said technologies, methods, and devices should be considered as part of the specification.

In all examples shown and discussed herein, any specific values should be interpreted as merely exemplary and not as limitations. Therefore, other examples of exemplary embodiments may have different values.

The present disclosure in one aspect provides a plant diagnosis method, which utilizes a plant diagnosis model to automatically process information obtained based on the user input to determine growth environment information and disease representation information of the plant, thereby determining the diagnosis result of the plant and providing the diagnosis result to the user, in order to enable the user to better maintain the plant.

The plant diagnosis method according to the present disclosure will be described in detail in conjunction with the accompanying drawings. It should be understood that the actual plant diagnosis method may include other additional steps, but in order to avoid ambiguity regarding the key points of the present disclosure, these other additional steps are not discussed herein and are not shown in the drawings.

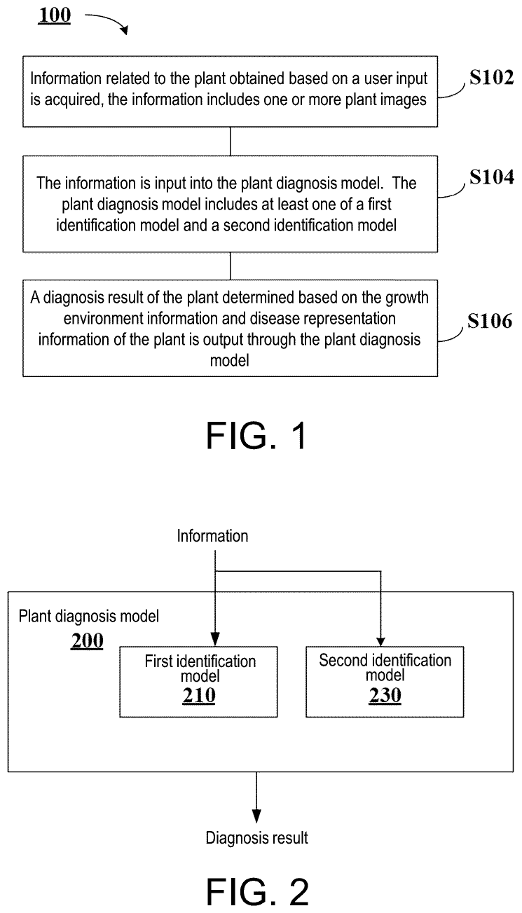

FIG. 1 shows a flowchart of a plant diagnosis method 100 (hereinafter referred to as “method 100”) according to some embodiments of the present disclosure. The method 100 may be executed by an application (APP) installed on electronic devices such as a computer, a mobile phone, etc., to provide plant diagnosis functions to a user. As shown in FIG. 1, the method 100 includes steps S102 to S106.

At step S102, information related to the plant obtained based on a user input is acquired, the information includes one or more plant images.

At step S104, the information is input into the plant diagnosis model. The plant diagnosis model includes at least one of a first identification model and a second identification model. The first identification model is configured to acquire growth environment information of the plant based on the information acquired at step S102, and the second identification model is configured to acquire disease representation information of the plant based on the information acquired at step S102.

At step S106, a diagnosis result of the plant determined based on the growth environment information and disease representation information of the plant is output through the plant diagnosis model.

In some embodiments, the information related to the plant may also include one or more plant texts related to at least one of the environment and disease of the plant in the one or more plant images. In such embodiments, the first identification model and/or the second identification model may process text in addition to processing images.

In some examples, the user input may include one or more of video, image, audio, and text related to the plant. For example, when the user input is a video, video decoding and other means may be used to acquire information including plant images from the user input, where the plant images may reflect the growth environment or disease representation of the plant. Speech recognition and other means may also be used to acquire information including plant text from the user input, where the plant text may be used to describe the growth environment or disease representation of the plant. It may be understood that if the identification model (e.g., the first identification model, the second identification model) is able to directly process data with the same modality as the user input, the user input may also be provided directly to the identification model without processing to extract corresponding information (e.g., growth environment information, disease representation information).

In some embodiments, the image may be one or more images associated with the plant, such as plant images that are able to present the overall appearance of the plant, plant images that can present the appearance of parts of the plant with diseases, or plant images that are able to present the growth environment of the plant. These images may be the same image or multiple different images. The plant image may help the plant diagnosis model acquire at least one of the growth environment information and disease representation information of the plant. Images that are able to present the growth environment situation of the plant may include images that are able to present the soil situation of the plant. Images that are able to present the growth environment situation of the plant may include images containing thermometers and/or hygrometers located in the growth environment of the plant.

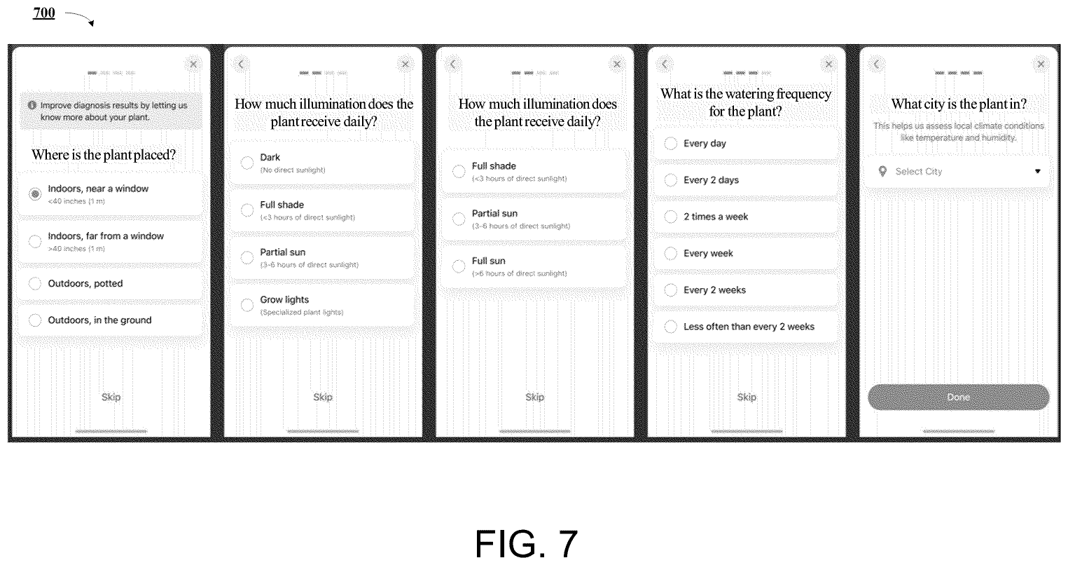

In some embodiments, in a situation where the plant diagnosis model does not include the first identification model, the information acquired at step S102 may include growth environment information of the plant. In some embodiments, in a situation where the plant diagnosis model does not include the second identification model, the information acquired at step S102 may include disease representation information of the plant. For example, the plant diagnosis model not including the first identification model means that the plant diagnosis model cannot extract growth environment information of the plant from complex non-standardized information. Therefore, interactive questions may be presented on an example user interface 700 of the plant diagnosis method according to some embodiments of the present disclosure as shown in FIG. 7 to enable users to input growth environment information of the plant in a standardized manner, thereby enabling the plant diagnosis model to directly acquire growth environment information of the plant without having to process (e.g., through the identification model) the user's reply to the interactive questions. Specifically, as shown in FIG. 7, interactive questions such as “Where is the plant placed?”, “How much illumination does the plant receive daily?”, “What is the watering frequency for the plant?”, “What city is the plant in?” may be presented on the user interface 700, and corresponding options may be provided for each question for the user to select, these options provide preset answers that may serve to standardize the user input. In another example, when the plant diagnosis model does not include the second identification model, interactive questions inquiring about the disease of the plant may be presented on the user interface 700, thereby directly providing disease representation information of the plant to the plant diagnosis model.

In some embodiments, the growth environment information of the plant may include one or more of illumination environment information, humidity environment information, air environment information, temperature environment information, soil environment information (soil moisture information, soil particle information) and nutrition environment information (soil health) of the growth environment of the plant. There may be overlap in different growth environment information of the plant. For example, high/low soil moisture may to some extent reflect sufficient/insufficient watering situation. The soil moisture information in humidity environment information and the soil moisture information in soil environment information, the soil fertility information in soil environment information and the soil nutrition information in nutrition environment information may be completely or partially overlapped.

Illumination environment information may include, for example, illumination duration information and/or illumination intensity information. Illumination intensity information may be categorized, for example, into good illumination or poor illumination.

Humidity environment information may include, for example, one or more of air humidity information, soil moisture information, and watering behavior information. Air humidity information may be, for example, air too dry, air too humid, or normal air humidity. Soil moisture information may be, for example, soil too dry, soil too wet, or normal soil moisture. Watering behavior information may be categorized, for example, into information including recently watered or not watered for a long time.

Air environment information may include, for example, one or more of degree of ventilation, wind force level, and wind direction. Degree of ventilation may include, for example, degree of ventilation of the plant root and/or degree of ventilation of the plant body, where the plant body refers to the part of the plant above the soil. The degree of ventilation of the plant body may be categorized, for example, into poor ventilation or normal ventilation.

Temperature environment information may include, for example, one or more of the air temperature at the time of diagnosis, the average air temperature within a preset time period, the highest air temperature within a preset time period, and the lowest air temperature within a preset time period. For example, the average air temperature within a preset time period may be compared with a preset value, thereby categorizing the average air temperature within the preset time period into temperature too high, temperature too low, and normal temperature.

Soil environment information may include, for example, one or more of soil moisture information, soil particle information, and soil fertility information. As mentioned above, soil moisture information may be, for example, soil too dry, soil too wet, or normal soil moisture. Soil particle information may be, for example, soil particles too large, soil particles too small, or normal soil particles. Soil particles that are too large may cause the plant to be unable to retain water, while soil particles that are too small may cause poor ventilation at the plant root. Soil fertility information may be categorized, for example, into insufficient soil fertility, excessive soil fertility, or normal soil fertility. Insufficient soil fertility may cause the plant to have nutrient deficiency diseases.

Nutrition environment information may include, for example, one or more of soil nutrition information, water nutrition information, and fertilization information. Soil nutrition information may include, for example, the soil fertility information mentioned above, and may also include information about nutritional elements in the soil. Water nutrition information may include, for example, information about nutritional elements in the water used to water the plant, as well as information about the pH (or hardness) of the water used. Fertilization information may include, for example, fertilization frequency information, information about nutritional elements in the applied fertilizer, etc.

The image of the plant may be acquired in real-time through a camera apparatus set up near the plant to obtain photos of the plant and photos of the growth environment of the plant. At the same time, sensors may be set up in the growth environment of the plant to acquire real-time information about the growth environment (including illumination environment information, humidity environment information, air environment information, temperature environment information, soil moisture information, soil particle information, and soil health of the growth environment of the plant) of the plant. The growth environment information of the plant may also be acquired through the set-up camera apparatus or in combination with various types of sensors. Sensors or camera apparatus may acquire user's watering behavior information, as well as geographic location information of where the plant is located. The camera apparatus and multiple sensors in combination may also establish a model of the environment to which the plant belongs, for example, determining whether the environment is indoor or outdoor, garden, botanical garden, greenhouse, or wild, etc. These camera apparatuses and multiple different sensors are connected to a server to process the acquired information. After processing and analyzing various types of information, the server may perform the necessary maintenance or disease treatment operations through various set-up maintenance apparatuses, such as controlling automatic sprinkler apparatus for watering or spraying pesticides, controlling ventilation apparatus, illumination supplementation apparatus, automatic soil-turning apparatus or automatic pruning apparatus, etc.

The installation location and number of camera apparatuses, sensors, maintenance apparatuses, disease treatment apparatuses and other equipment may be adjusted according to different plants and different environments. After acquiring preliminary original environment information through the camera apparatuses, installation suggestions and guidance information may be provided.

In some embodiments, the disease representation information of the plant may include one or more of leaf spots, brown spots, excessive elongation and weakness, basal soft rot, flowering lodging, stem softening and lodging, leaf mold spots, mold on young fruits, leaf yellowing and withering, and insect bite damage. Excessive elongation and weakness refers to, for example, the phenomenon where the plant's stems and leaves develop excessively while the branches and trunk are thin and excessively elongated. Basal soft rot refers to, for example, the softening and even rotting of the part where the plant's stem and root interface.

In some embodiments, the diagnosis result of the plant includes the cause of disease that causes the disease of the plant. The cause of disease may include one or more of lack of illumination, excessive illumination, lack of watering, excessive watering, poor ventilation, excessively high temperature, excessively low temperature, overly dry soil, overly wet soil, soil compaction, overly large soil particles, lack of pruning, lack of fertilizer, bacterial infection, pest and disease, soil salinization, and root rot.

It should be understood that the above-listed content is only used to describe the growth environment information, disease representation information, diseases, and causes of disease of the plant in an exemplary manner, and not to limit the scope of this disclosure.

Since the growth environment of the plant will directly affect the plant's growth pattern, when diagnosing plants, the growth environment information and disease representation information of the plant may be combined to more accurately determine the diseases occurring in the plant and the cause of disease corresponding to the disease.

FIG. 2 shows a schematic block diagram of a plant diagnosis model 200 according to some embodiments of this disclosure. As shown in FIG. 2, the plant diagnosis model 200 includes a first identification model 210 and a second identification model 230. The first identification model 210 is configured to acquire the growth environment information of the plant based on information, and the second identification model 230 is configured to acquire the disease representation information of the plant based on information. The first identification model 210 and the second identification model 210 may be trained respectively through sample-labeled data containing multiple modalities, and these multiple modalities may include images. Of course, these multiple modalities may also include one or more modalities such as text, audio, video, etc. besides images. Through joint training on data in different modalities such as images, text, etc., the identification model may learn the correspondence between different modalities, thereby realizing cross-modal information expression and inference capabilities. In addition, through training data specific to the plant domain, diagnosis capabilities for plants are also introduced into the identification model.

In some examples, images reflecting the growth environment of the plant may be used as sample images and these sample images may be labeled. For example, on each sample image, labeling may be performed for classified situations such as illumination environment information, humidity environment information (watering situation), air environment information (ventilation situation), soil moisture information, soil particle information, and soil health. The specific implementation method of sample labeling may refer to the content of growth environment information labeling for plant diagnosis as shown in Table 1.

TABLE 1

| Growth | | | |
|---|---|---|---|
| environment | | | |
| information | Value | Classification | Labeling rules |
| Illumination | 1 | Good illumination | Located outdoors with shadows in the image; or, |
| environment | | | located indoors near a windowsill with shadows in the |
| information | | | image |
| | 2 | Poor illumination | Located outdoors or in a corner with the entire image |
| | | | in shadow; or, located indoors, in a corner with no |
| | | | windows or clearly far from windows |
| | 3 | Other | Not belonging to the two situations mentioned above |
| Humidity | 1 | Just watered | Leaves, stems and other parts have obvious water |
| environment | | | marks |
| information | 2 | Watermark-free | Not belonging to the above situations |
| Air | 1 | Poor ventilation | From the image background, it is clearly perceptible |
| environment | | | that in a range close to or exceeding 180 degrees, there |
| | | | are obstacles that reach a preset height and will lead |
| | | | to poor ventilation for the plant |
| information | 2 | Normal ventilation | Not belonging to the above situations |
| Soil moisture | 1 | Soil too dry | Soil dryness, it is obvious that the plant has not been |
| information | | | watered for a long time |
| | 2 | Soil over-wetness | Soil is moist, water traces can be seen; or, the tray |
| | | | under the flowerpot has accumulated water |
| | 3 | Normal soil | Not belonging to the above situations |
| | | moisture | |
| Soil particle | 1 | Soil particles too | The granular texture is obvious |
| information | | large | |
| | 2 | Soil particles too | Granular texture is not observed, and there is |
| | | small | clumping and so on |
| | 3 | Normal soil | Not belonging to the above situations |
| | | particles | |
| Soil health | 1 | Fungus/pathogen | Soil contains mold, pathogens, pests or harmful |
| | | | nematodes |
| | 2 | Salinization | Excessive salt in the soil |
| | 3 | Normal | Not belonging to the above situations |

Sample images may be labeled according to the labeling rules in Table 1. For example, if a sample image shows a plant located outdoors with shadows in the image, the plant's leaves and stems have obvious water marks, there are no ventilation obstacles, the tray under the flower pot has accumulated water, and the soil has visible particles but is healthy, then, the labeling result of this sample image may be [1, 1, 2, 2, 1, 3], where each element respectively represents the classification of illumination environment information, humidity environment information, air environment information, soil moisture information, soil particle information, and soil health of the growth environment of the plant.

Similarly, images reflecting the disease representation of the plant may also be used as sample images and these sample images may be labeled for training the second identification model. For example, labeling may be performed on each sample image for classified situations such as leaf spots, brown spots, excessive elongation and weakness, basal soft rot, flowering lodging, stem softening and lodging, leaf mold spots, mold on young fruits, leaf yellowing and withering, and insect bite damage. It may be understood that there may exist images that are able to reflect both the growth environment and the disease representation of the plant, such images may be used to train both the first identification model and the second identification model.

In the growth process of plants, there are often some growth environment problems or disease representation problems that are uncommon or less noticed, but they are numerous and may have significant impact overall. These problems may not be as obvious as the main problems, but their cumulative effects may eventually significantly affect the growth pattern of the plant. These problems may be called “long-tail problems. In the method 100, by using multimodal data after sample labeling as training data for the first identification model and the second identification model, the trained first identification model and second identification model may extract more plant growth environment information and disease representation information from different modalities, thus not being limited by the modality of the user input or the scope of sample labeling. In this way, the plant diagnosis model may concurrently diagnose long-tail problems and output more accurate diagnosis results.

In some embodiments, the first identification model includes a first image processing model capable of processing plant images and trained using a first subset of the first training data, and a first text processing model capable of processing plant text and trained using a second subset of the first training data. In this embodiment, the first subset of the first training data includes sample plant images and growth environment information labeled for the sample plant images, and the second subset of the first training data includes sample plant text and growth environment information labeled for the sample plant text.

In some embodiments, the second identification model includes a second image processing model capable of processing plant images and trained using a first subset of the second training data, and a second text processing model capable of processing plant text and trained using a second subset of the second training data. In this embodiment, the first subset of the second training data includes sample plant images and disease representation information labeled for the sample plant images, and the second subset of the second training data includes sample plant text and disease representation information labeled for the sample plant text.

In some examples, the image processing model may include models applying conventional image processing algorithms, may also be machine learning models (such as support vector machine (SVM), etc.), may also be deep learning models (such as convolutional neural networks (CNN), etc.), and may also be generative models (such as generative adversarial network (GAN), etc.).

In some examples, the text processing model may include models applying conventional text feature extraction algorithms, may also be deep learning models (such as long short-term memory (LSTM), etc.), and may also be pre-trained models (such as generative pre-trained transformer (GPT), etc.).

In further embodiments, at least one image processing model of the first image processing model and the second image processing model is a multimodal model capable of processing images. That is, such a multimodal model, in addition to processing images, may also process data of one or more other modalities, such as video, audio, text, etc.

In further embodiments, at least one text processing model of the first text processing model and the second text processing model is a multimodal model capable of processing text. That is, such a multimodal model, in addition to processing text, may also process data of one or more other modalities, such as video, audio, images, etc.

In some embodiments, the first identification model includes a first multimodal model capable of processing both plant images and plant text. The first multimodal model is trained using first multimodal data. The first multimodal data includes both sample plant images and sample plant text as well as growth environment information labeled for the sample plant images and sample plant text. In some examples, the first multimodal model, in addition to processing images and text, may also process data of one or more other modalities, such as video, audio, etc.

In some embodiments, the second identification model includes a second multimodal model capable of processing both plant images and plant text. The second multimodal model is trained using second multimodal data. The second multimodal data includes both sample plant images and sample plant text as well as disease representation information labeled for the sample plant images and sample plant text. In some examples, the second multimodal model, in addition to processing images and text, may also process data of one or more other modalities, such as video, audio, etc.

In further embodiments, the first multimodal model may include a first visual model and a first multimodal large language model. The first visual model is configured to receive a first plant image from one or more plant images to extract first image features of the first plant image. The first multimodal large language model is configured to receive the first image features and a first plant text from one or more plant texts to extract growth environment information.

In further embodiments, the second multimodal model includes a second visual model and a second multimodal large language model. The second visual model is configured to receive a second plant image from one or more plant images to extract second image features of the second plant image. The second multimodal large language model is configured to receive the second image features and a second plant text from one or more plant texts to extract disease representation information.

Here, the first plant image and the first plant text may be images and text related to the growth environment of the plant, respectively, and the second plant image and the second plant text may be images and text related to the disease of the plant, respectively. The first plant image, the first plant text and the second plant image, the second plant text may be completely identical, partially identical, or completely different.

The visual capability of a multimodal large language model may primarily depend on the corresponding visual model, especially the image features extracted by the visual model. Therefore, the expressive ability of the image features of the visual model will directly affect the performance of the multimodal large language model on visual tasks for plant diagnosis.

The visual model may be based on various suitable network architectures, such as ResNet, DenseNet, contrastive language-image pre-training (CLIP) model, etc. In some examples, the visual model may be a convolutional neural network (CNN) transformer model, such as but not limited to the ConvNext model. To improve the expressive ability of such visual models in the field of plant diagnosis, they may be trained through contrastive learning using plant image-text pairs. For example, the CNN transformer model may first be separately pre-trained through contrastive learning using plant image-text pairs, and then jointly trained with the corresponding multimodal large language model using multimodal data. This helps to improve the overall performance of the model. Of course, it is also possible to first pre-train the CNN transformer model separately, and then fix the parameters of the CNN transformer model while only updating the parameters of the multimodal large language model when training the entire identification model with multimodal data, which may speed up training and reduce the computational and storage resources consumed by training.

After acquiring the growth environment information and disease representation information of the plant through the first identification model and/or the second identification model, in some embodiments, outputting the diagnosis result of the plant determined based on the growth environment information and disease representation information of the plant through the plant diagnosis model may include: determining the cause of disease of the plant corresponding to the growth environment information and disease representation information of the plant based on a correspondence relationship between growth environment information, disease representation information and cause of disease of the plant pre-stored in a database; including at least one of the determined cause of disease and a processing method for the determined cause of disease in the diagnosis result of the plant. In some embodiments, the processing method may include at least one of a treatment method for the disease and maintenance suggestions for the plant.

The electronic device may control an automatic sprinkler apparatus to water or spray pesticides based on the diagnosis result; or, the electronic device may control a transport apparatus (such as a transport robot, etc.) to move the plant body to a designated position based on the diagnosis result; or, the electronic device may control a ventilation apparatus to turn on fans to enhance exhaust, or open vents, etc. based on the diagnosis result; or, the electronic device may control an illumination supplementation apparatus to increase or decrease illumination based on the diagnosis result; or, the electronic device may control an automatic soil-turning apparatus to move to a designated position to perform soil-turning actions based on the diagnosis result; or, the electronic device may control an automatic pruning apparatus to prune specified parts of the plant based on the diagnosis result.

In some embodiments, the information acquired in step S102 may also include other information about the plant, and outputting the diagnosis result of the plant determined based on the growth environment information and disease representation information of the plant through the plant diagnosis model includes outputting the diagnosis result of the plant determined based on the growth environment information, disease representation information and other information of the plant through the plant diagnosis model. For example, the other information may include one or more of the density situation of the plant, the growing location of the plant, the time associated with the plant being diagnosed, and the maintenance method of the plant. The density situation of the plant, the growing location of the plant, the time associated with the plant being diagnosed, and the maintenance method of the plant may be directly acquired from the user through human-computer interaction, and/or acquired from images input by the user through computer vision technology.

The density situation of the plant, for example, is divided into appropriate density of plant and excessive density of plant. The growing location of the plant, for example, is one or more of the latitude and longitude, administrative division, and climate zone where the plant's growing location is situated. The growing location of the plant, for example, may be obtained by the application program reading the location information of the terminal where the plant is located, or may be extracted from the metadata of the image input by the user. For example, if the growing location indicates that the plant is growing in the tropics, the temperature environment information of the plant may be determined accordingly, such as possibly excessively high temperature for outdoor plants. The time associated with the plant being diagnosed, for example, is the moment of determining the cause of disease and/or the moment when the user captures the image. The moment of determining the cause of disease, for example, is the moment when the application program executes the operation of determining the cause of disease. The moment when the user captures the image, for example, is the moment of extracting from the metadata of the image input by the user. For example, if the time associated with the plant being diagnosed indicates that the moment when the user captures the image is in winter, the temperature environment information of the plant may be determined accordingly, such as possibly too low temperature for outdoor plants. For example, if the growing location indicates that the plant is growing in the tropics, and the time indicates that it is in the rainy season, the temperature environment information and humidity environment information of the plant may be determined accordingly, such as possibly excessively high temperature and excessive air humidity for outdoor plants.

The maintenance method of the plant, for example, is one or more of the user's watering frequency, watering amount, fertilizing frequency, fertilizer type, fertilizing amount, and pruning frequency. As some implementations, the application program may record the user's maintenance method, thereby determining the cause of disease in combination with the historical maintenance method recorded in the application program. As other implementations, the maintenance method of the plant may be directly acquired from the user through human-computer interaction.

In some examples, the cause of disease may be determined based on growth environment information, disease representation information, and other plurality of information. For example, if the growth environment information indicates poor illumination and excessive soil moisture, the disease representation information indicates that the plant is excessively elongated and weak, the growing location of the plant indicates that the plant is in a subtropical area, the time associated with the plant being diagnosed indicates that at the time of capturing the image, and the growing location is in spring, accordingly, the cause of disease may be determined to be lack of illumination and root rot. As another example, if the growth environment information indicates good illumination, the disease representation information indicates that the stem is softening and lodging, the growing location of the plant indicates that the plant is in a subarctic area, the time associated with the plant being diagnosed indicates that at the time of capturing the image, and the growing location is in winter, accordingly, the cause of disease may be determined to be excessively low temperature.

For example, a correspondence table of growth environment information, disease representation information, other information, and causes of disease as shown in Table 2 may be pre-established in a database, in order to determine the cause of disease of the plant based on the growth environment information, disease representation information, and other information of the plant.

TABLE 2

| | | | | | Other | |
|---|---|---|---|---|---|---|
| | Growth environment information | | | | information | |
| Disease | Illumination | Soil | Soil | Air | Density | |
| representation | environment | moisture | particle | environment | situation of | Cause of |
| information | information | information | information | information | plant | disease |
| Excessive | Bad | Normal | | | Appropriate | Lack of |
| elongation | | | | | | illumination |
| and weakness | Bad | Excessive | | | Appropriate | Lack of |
| | | moisture | | | | illumination + |
| | | | | | | root rot |
| | Good | Normal | | | Appropriate | Lack of |
| | | | | | | fertilizer |
| | Good | Excessive | | | Appropriate | Lack of |
| | | moisture | | | | fertilizer + |
| | | | | | | root rot |
| | | | | | Excessively | Lack of |
| | | | | | high density | pruning |
| Basal soft rot | | Excessive | | | | Root rot |
| | | moisture | | | | |
| Flower | | | | | High density | Lack of |
| lodging | | | | | | pruning |
| | Good | | | | Appropriate | Lack of |
| | | | | | | fertilizer |
| | Bad | | | | Appropriate | Lack of |
| | | | | | | illumination |
| Stem | | Excessive | | | | Root rot |
| softening and | | moisture | | | | |
| lodging | | Normal or | | | | Lack of |
| | | dry | | | | watering |
| Leaf mold | | | | Poor | | Poor |
| spots | | | | | | ventilation |
| Mold on | | | | Poor | | Poor |
| young fruit | | | | | | ventilation |
| Leaf | | Normal | Too small, | | | Soil |
| yellowing and | | | soil | | | compaction |
| withering | | | clumping | | | |
| | | Normal | Excessively | | | Soil |
| | | | large | | | particles too |
| | | | | | | large |

As shown in Table 2, the cause of disease may be determined according to the disease representation information, growth environment information, other information, and the correspondence relationship. For example, when the disease representation information indicates that the plant is excessively elongated and weak, and the density situation of plant indicates that the plants are too dense, the cause of the disease may be determined to be lack of pruning. As another example, when the disease representation information indicates that the leaves are withered and yellow, the growth environment information indicates that the soil moisture is normal, the soil particle size is too small, and the soil is clumping, the cause of the disease may be determined to be soil compaction. It should be understood that Table 2 is only used to exemplarily describe the correspondence relationship between the growth environment information of the plant, the disease representation information of the plant, and the cause of disease, rather than to limit the scope of this disclosure.

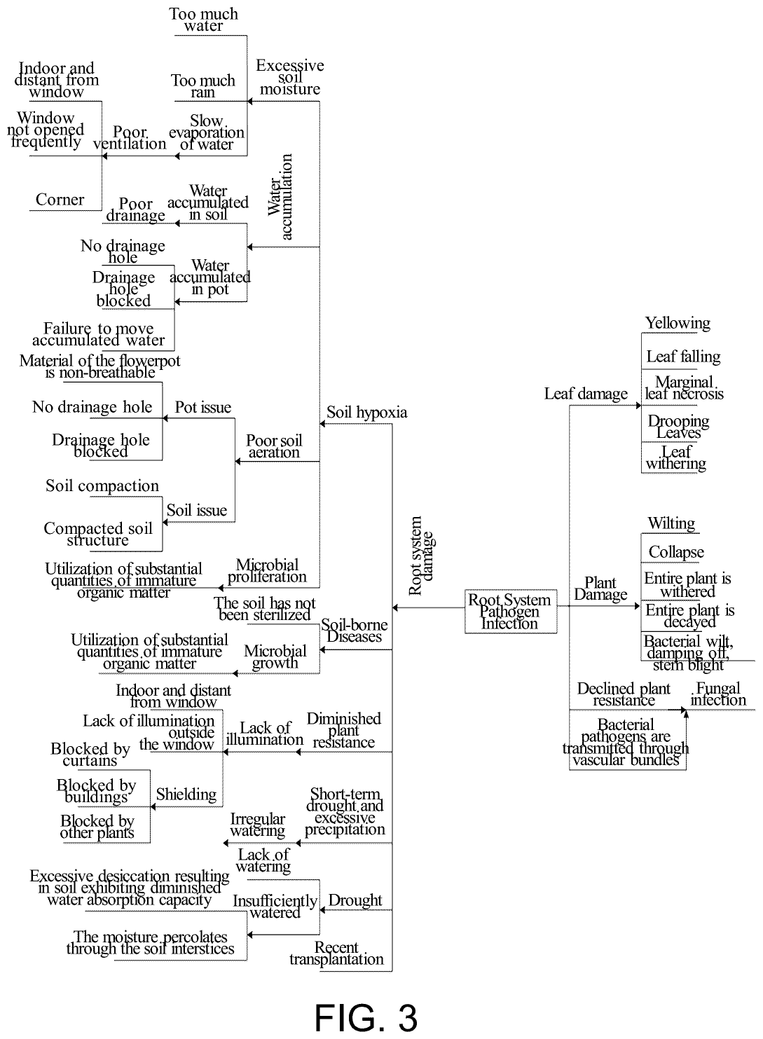

In some examples, a chain of thought of growth environment information, disease representation information, other information, and cause of disease as shown in FIG. 3 may also be pre-established in a database.

It should be understood that Table 2 and FIG. 3 are only used to exemplarily describe the correspondence relationship between the growth environment information of the plant, the disease representation information of the plant, other information, and the cause of disease, rather than to limit the scope of this disclosure.

In some examples, the database may also store the plant name, plant maintenance information, plant diseases, causes of disease, and corresponding treatment and prevention methods, etc. This information about the plant may be stored in the database in association with the image features of the plant. Information may be extracted based on the matching degree between the image features of the identified plant image and the image features of the plant stored in the database, for example, when the matching degree falls within a preset range. As a non-limiting example, a cosine similarity between a first vector representing the image features of the identified plant image and a second vector representing the image features of the plant stored in the database may be calculated. When the calculated cosine similarity exceeds a preset threshold, it may be considered that the image features of the identified plant image match the image features of the plant stored in the database, and the information stored in the database in association with the matched image features may be extracted as part of the diagnosis result.

In some embodiments, after confirming the cause of disease of the plant based on the growth environment information, disease representation information, and other information (if any) of the plant, the corresponding processing method may also be determined through the plant diagnosis model based on the cause of disease and the treatment and prevention methods, maintenance information pre-stored in the database and associated with the cause of disease or the diseases it causes.

For example, when the disease representation information of the plant is severe yellowing of the upper leaves of the plant body, yellow spots on the leaves, and the plant is infected with bacteria, and the growth environment information of the plant is poor ventilation and soil compaction, the cause of disease of the plant may be determined to be poor soil permeability, poor ventilation, and pest and disease. The corresponding processing method may be: controlling the transport apparatus to move the plant body to a designated location (such as a more ventilated location) based on the maintenance suggestion, controlling the automatic pruning apparatus to prune the designated parts (removing the yellowed leaves), and controlling the automatic spraying apparatus to spray insecticide based on the maintenance suggestion.

For example, when the disease representation information of the plant is mold on young fruits, the growth environment information of the plant is poor ventilation, and other information of the plant is that the plants are too dense, the cause of disease may be determined to be poor ventilation inside the plant body. The corresponding processing method may be: controlling the transport apparatus to move the plant to a designated location (such as a more ventilated location) based on the maintenance suggestion, and controlling the automatic pruning apparatus to prune the designated parts, such as removing the overly dense leaves (for example, about 10 leaves) at the lower part of the plant body to expose the young fruits, and also promptly cutting off the moldy young fruits to prevent other young fruits from becoming moldy.

For example, when the disease representation information of the plant is that some branches at the base of the plant are withered and the plant body as a whole appears dwarfed, and the growth environment information of the plant is excessive illumination and poor internal ventilation, the cause of disease may be determined to be excessive illumination and poor ventilation. The corresponding processing method may be: controlling the transport apparatus to move the plant body to a designated location (such as a place with relatively weaker illumination and relatively higher humidity) based on the maintenance suggestion, so that the plant is able to grow normally.

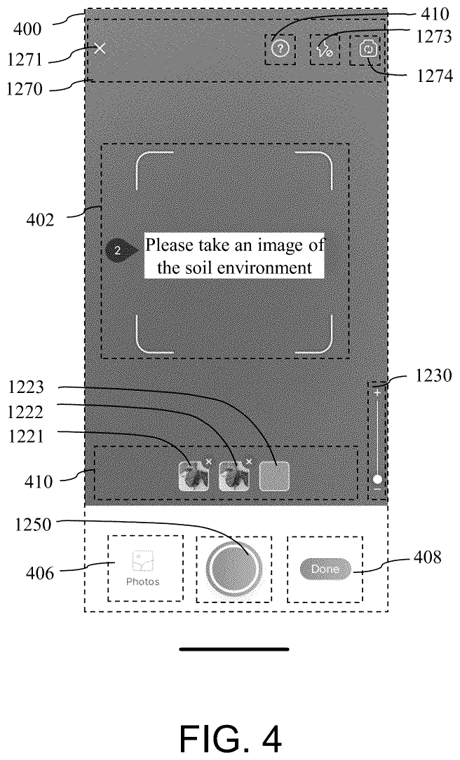

In some embodiments, before user input, prompts may be displayed to the user to guide the user in capturing or describing the plant body and/or growth environment of the plant. Referring to FIG. 4, FIG. 4 shows a schematic diagram of an example user interface 400 of the plant diagnosis method according to some embodiments of the present disclosure. As shown in FIG. 4, the user interface 400 may include a prompt area 402 for displaying capturing prompts to the user. The capturing prompts may be presented in the form of text information, such as “Please take an image of the soil environment”. By displaying capturing prompts to guide the user in capturing, it is conducive to acquiring plant images that are able to provide growth environment information of the plant, avoiding repeated capturing or inaccurate diagnosis results due to the user not knowing what kind of images should be taken to complete the plant diagnosis, thereby improving the accuracy of the plant diagnosis results and improving the user experience. Moreover, it is conducive to acquiring images that are easy to identify using computer vision technology, thereby improving the accuracy of determining growth environment information and/or disease representation information from images using computer vision technology, and further improving the accuracy of determining the cause of disease. In some examples, the capturing prompts may also be presented in the form of images (e.g., sample images) or video (e.g., capturing tutorials) information. Automatic capturing may be performed through the set camera apparatus. The camera apparatus may be arranged at multiple positions and angles, or it may be a camera apparatus that moves along a rail.

In some embodiments, the capturing prompts may be determined based on the images already input. As some implementations, after acquiring at least one image of one or more images, and before acquiring all images of the one or more images, capturing prompts may be displayed to guide the user in capturing the remaining images other than the acquired images from the one or more images. Here, the one or more images include: images that may present the overall appearance of the plant, images that may present the appearance of the parts of the plant with diseases, and images that may present the situation of the growth environment of the plant. For example, when the acquired images are able to present the overall appearance of the plant and able to present the appearance of the parts of the plant with diseases, the capturing prompt displayed to the user may be “Please acquire images that are able to present the situation of the growth environment of the plant”. Determining capturing prompts based on acquired images makes the capturing prompts targeted, which is conducive to better guiding the user in capturing, thereby further improving the accuracy of determining growth environment information and/or disease representation information from images using computer vision technology, and further improving the accuracy of determining the cause of disease.

The user interface 400 may also include a display area 404. The display area 404 is configured to display images that have been captured and/or are to be captured. The captured images refer to images that the user confirms to provide to the application program including the plant diagnosis model but have not yet been used for plant diagnosis. After the user performs a specific operation (such as the operation on the submit button 408 that will be mentioned later), the application program will perform plant diagnosis based on the image.

The display area 404 may have multiple sub-areas, each sub-area may correspond to an acquired and/or to-be-captured image. For example, when there are two acquired images, the display area 404 may have 3 sub-areas, wherein a sub-area 1221 and a sub-area 1222 are configured to display thumbnails of the two acquired images respectively. The sub-area 1223 is a blank area, corresponding to the image to be captured. A delete button may be displayed in the upper right corners of the sub-area 1221 and the sub-area 1222. In response to the user's operation on the delete button, the image corresponding to the sub-area where the delete button is located will no longer be used as an acquired image, and the image will not be used for plant diagnosis subsequently. To replace the deleted image, the user may re-capture or re-upload a new image.

In some embodiments, the user interface 400 may also include an area 1230 for displaying a screen size adjustment button. The user may operate the screen size adjustment button to zoom in or zoom out the screen to be captured, adjusting the range of the image to be captured.

The user interface 400 may also include a button 406 for opening the photo album. By clicking the button 406, the user may open the photo album of the user terminal, whereby the user may select images from the photo album, and the selected images will serve as captured images.

The user interface 400 may also include an area 1250 for displaying the capturing button. The user may operate the capturing button to capture plant images. As some implementations, after the user operates the capturing button, the image captured by the user will become an acquired image, and correspondingly, the sub-area 1223 will display a thumbnail of the image captured by the user.

The user interface 400 may also include a submit button 408 for submitting captured images. The user may provide captured images by clicking the submit button 408, so that the application program may perform plant diagnosis based on the captured images.

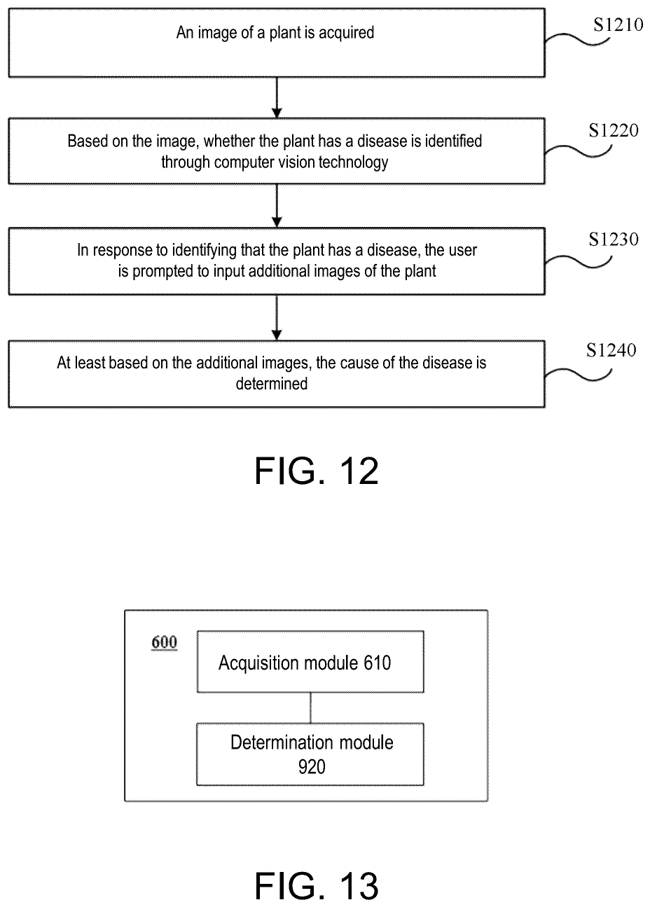

The user interface 400 may also include an area 1270. The area 1270 may include, for example, a capturing interface close button 1271, a capturing prompt display button 410, a flash setting button 1273, and a capturing screen flip button 1274. In response to the user's operation on the capturing interface close button 1271, the capturing screen shown in FIG. 12 may be closed. In response to the user's operation on the flash setting button 1273, the flash may be turned off or on. In response to the user's operation on the capturing screen flip button 1274, switching between the front camera and the rear camera may be performed.

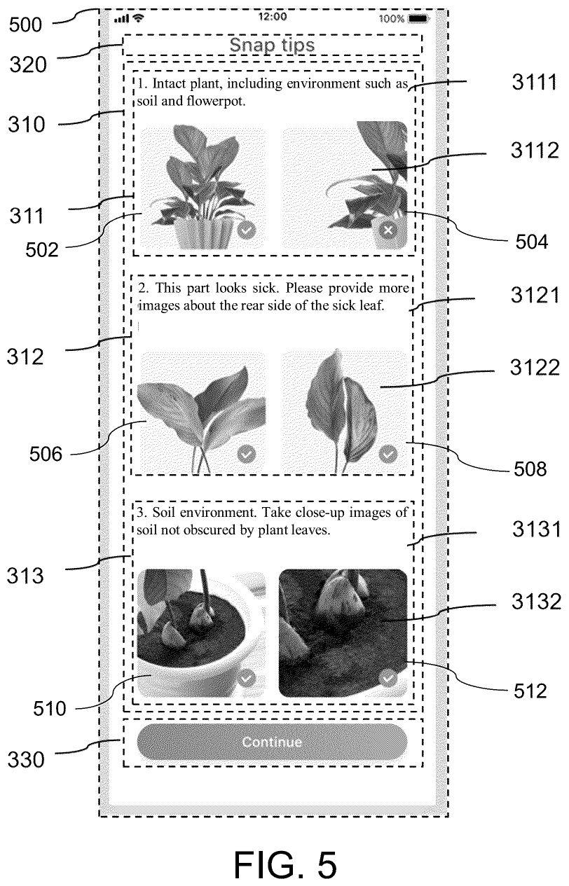

In response to the user's operation on the capturing prompt display button 410, capturing prompts may be displayed to the user, where the capturing prompts here may be different from the capturing prompts displayed in the area 1210, such as the capturing prompt interface shown in FIG. 5. The capturing prompts here may be preset, or may be determined based on the input images (the determination process may be derived from the description above).

The user interface 500 shown in FIG. 5 is introduced below. As some implementations, in response to the user's operation on the capturing prompt display button 410, the user interface 500 shown in FIG. 5 may be displayed to the user. As other implementations, before the user enters the capturing interface shown in FIG. 4, the user interface 500 shown in FIG. 5 may be displayed to the user.

The user may open the example user interface 500 as shown in FIG. 5 by clicking the capturing prompt button 410. The user interface 500 may be used to display capturing prompts including text and images: the text prompt “1. Intact plant, including environment such as soil and flowerpot” along with a front example image 502 and a rear example image 504; the text prompt “2. This part looks sick. Please provide more images about the rear side of the sick leaf” along with front example images 506 and 508; and “3. Soil environment. Take close-up images of soil not obscured by plant leaves” along with front example images 510 and 512.

The user interface 500 may include an area 310 for displaying capturing prompts. The area 310 may include multiple sub-areas, such as a sub-area 311, a sub-area 312, a sub-area 313, with each sub-area displaying one type of capturing prompt. For example, the sub-area 311, the sub-area 312, and the sub-area 313 are respectively used to display the following three types of capturing prompts: please provide images that are able to present the overall appearance of the plant, please provide images that are able to present the appearance of the part of the plant with the disease, and please provide images that are able to present the situation of the growth environment of the plant.

The sub-area may include text prompts and/or image prompts. For example, the sub-area 311 includes text prompt 3111 and image prompt 3112. The content of text prompt 3111 is, for example, “Intact plant, including environment such as soil and flowerpot”. The image prompt 3112 schematically shows images that conform to the content of the text prompt 3111 and images that do not conform to the content of the text prompt 3111, and correct icons and error icons are correspondingly labeled on the images. By combining text prompts and image prompts, it is conducive for users to quickly and intuitively understand the requirements of plant capturing, which helps to improve user experience and improve the accuracy of determining the cause of disease.

In some embodiments, the image prompt may also only show images that conform to the content of the text prompt. For example, the sub-area 312 includes the text prompt 3121 and the image prompt 3122. The content of the text prompt 3121 is “This part looks sick. Please provide more images about the rear side of the sick leaf”. Correspondingly, the image prompt 3122 shows the front image and rear image of the part of the plant body with diseases. In another example, the sub-area 313 includes the text prompt 3131 and the image prompt 3132. The content of the text prompt 3131 is “Soil environment. Take close-up images of soil not obscured by plant leaves”. Correspondingly, the image prompt 3132 shows two soil images that meet the requirements.

In some embodiments, the user interface 500 may also include an area 320 for displaying the interface name, so that the user can quickly understand the function of the capturing prompt interface.

In some embodiments, the user interface 500 may also include an area 330, configured to display a continue display button and/or an end display button. For example, FIG. 13 shows a continue display button, in response to the user's selection operation on the continue display button, other capturing prompts that have not yet been displayed may be displayed to the user in the area 310. In another example, in some other embodiments, in response to the user's selection operation on the end display button, the user interface 500 may be closed.

In some embodiments, in response to the user's need for expert diagnosis, the information of the plant may be submitted to experts for diagnosis. Here, the information of the plant includes one or more of growth environment information, disease representation information, one or more images associated with the plant, and the method of maintaining the plant. The one or more images associated with the plant may include, for example, images that are able to present the overall appearance of the plant, images that are able to present the appearance of the part of the plant with diseases, and images that are able to present the situation of the growth environment of the plant, etc.

In some embodiments, in the situation where the diagnosis result of the plant cannot be determined based on the currently acquired growth environment information and disease representation information of the plant, interactive questions about identifying at least one of the growth environment information and disease representation information of the plant are displayed to the user, and replies to the interactive questions are acquired from the user, and the replies are input to the plant diagnosis model, to output the diagnosis result of the plant determined based on the growth environment information and disease representation information of the plant and the reply through the plant diagnosis model. In some embodiments, the interactive questions may include a request for one or more of close-up images of the diseased parts or growth environment of the plant, the time when the plant image was taken, and the location where the plant image was taken.

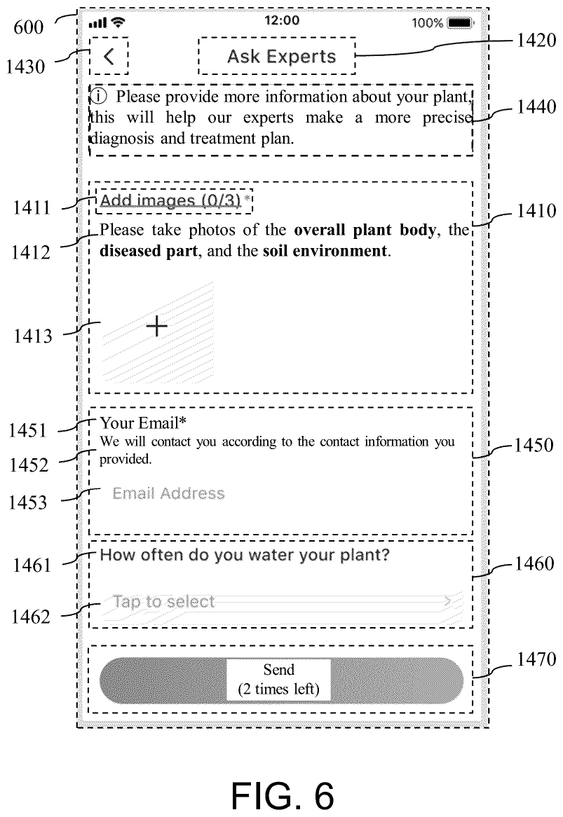

In some examples, the interactive question may be an example prompt statement for guiding the user to take photos or provide descriptions. For example, the interactive question may be an example prompt statement “Take photos of the entire plant, the diseased part, and the soil environment” in the example user interface 600 as shown in FIG. 6.

As shown in FIG. 6, the user interface 600 may include an image submission area 1410, so that the user can submit images. The image submission area 1410 may include an area name 1411, an image submission prompt 1412, and an image submission sub-area 1413.

The area name 1411 is, for example, “Add Images”. As some implementations, the area name 1411 may also carry the total number of images that need to be submitted and the total number of images that the user has submitted. For example, in the situation where the total number of images that need to be submitted is 3, and the total number of images that the user has submitted is 0, the area name 1411 may be “Add Images (0/3)”. As some implementations, the area name 1411 may also carry a specific mark, so that the user knows that they must submit images, for example, it may carry a specific mark “*” so that the area name 1411 is “Add Images (0/3)*” to show that this operation item is a required item.

The image submission prompt 1412 is used to display suggestions for the submitted images to the user, for example, “Please take photos of the overall plant body, the diseased part, and the soil environment”. As some implementations, part of the text in the image submission prompt may be emphasized through bold, italics, underlining, and other methods to attract the user's attention, so that the user can grasp the key parts in the image submission prompt 1412, for example, “overall plant body”, “diseased part”, and “soil environment” may be bolded.

The image submission sub-area 1413 is set to be interactive, and the user may interact with the image submission sub-area 1413 to add one or more images for submission.

In some embodiments, the user interface 600 may also include an interface name 1420, so that the user can quickly understand the content of the interface. The interface name 1420 is, for example, “Ask Experts”.

In some embodiments, the user interface 600 may also include an area 1430 for displaying an interface return button. In response to the user's operation on the interface return button, the user interface 600 may be closed, and other pages may be displayed.

In some embodiments, the user interface 600 may also include an area 1440 for displaying prompts related to the expert diagnosis page. For example, the prompt related to the expert diagnosis page may be “Please provide more information about your plant, this will help our experts make a more precise diagnosis and treatment plan”.

In some embodiments, the user interface 600 may also include an area 1450 for acquiring the user's contact information, in order to provide the expert diagnosis result to the user through the user's contact information subsequently. The area 1450 may include an area name 1451, an area function introduction 1452, and a user fill-in sub-area 1453. The area name 1451 is, for example, “Your Email”. As some implementations, the area name 1411 may also carry a specific mark, so that the user knows that they must submit their contact information, for example, the area name may be “Your Email*”. The area function introduction 1452 is, for example, “We will contact you according to the contact information you provided”. The user fill-in sub-area 1453 is set to be interactive, and the user may fill in their email address and other contact information here.

In some embodiments, the user interface 600 may also include an area 1460 for acquiring the maintenance method for the plant. The area 1460 may include at least one sub-area, each sub-area may acquire one aspect of the maintenance method. For example, there may be 2 sub-areas, one sub-area for acquiring information related to watering, and another sub-area for acquiring information related to fertilization. Each sub-area may include a question 1461 related to the maintenance method and a maintenance method input sub-area 1462. For example, the question 1461 related to the maintenance method may be “How often do you water your plant”. The maintenance method input sub-area 1462 is, for example, interactive. As some implementations, after the user clicks on the maintenance method input sub-area 1462, multiple options corresponding to the question 1461 related to the maintenance method may appear, from which the user may make a selection. As other implementations, the user may directly input relevant information in the maintenance method input sub-area 1462.

In some embodiments, the user interface 600 may also include an area 1470 for displaying a send button. In response to the user's operation on the send button, the application program may send the user-submitted images, contact information, and maintenance method information to the server, so that the server can send this information to experts for diagnosis. As some implementations, the number of times a user uses the service of expert diagnosis may be limited, and the send button may also carry the number of times the user may uses the service of expert diagnosis. For example, if the user is allowed to use the service of expert diagnosis 2 more times, then the content of the send button may be “Send (2 times left)”.

In other examples, the interactive question may be various multiple-choice questions in the example user interface 700 as shown in FIG. 7, so that the user may provide more growth environment information of the plant and/or disease representation information of the plant by selecting different option answers. Of course, the interactive question may also take the form of open-ended question.

Whether or not the growth environment information and disease representation information of the plant currently acquired based on the plant diagnosis model is sufficient to determine the diagnosis result of the plant, these interactive questions may be displayed to the user in order to acquire more information for the plant diagnosis model for diagnosis. In this way, the accuracy of the diagnosis may be improved.

The diagnosis result of the plant may include the cause of disease of the plant and the corresponding processing method. Therefore, in some embodiments, after obtaining the diagnosis result, related maintenance tasks may be generated and displayed to the user according to the content in the diagnosis result. In the case of being connected to an apparatus that is able to execute maintenance tasks, the corresponding apparatus may also be automatically controlled to execute the maintenance task.

Specifically, in some embodiments, the method 100 may include: generating a maintenance plan according to the diagnosis result, the maintenance plan includes one or more pairs, each pair in the one or more pairs includes one or more maintenance tasks and identification of a maintenance apparatus for executing the one or more maintenance tasks; outputting the maintenance plan.

The maintenance plan may include daily maintenance plans, treatment maintenance plans, preventive maintenance plans, etc., or combinations thereof. For example, when the diagnosis result does not involve the disease or cause of disease of the plant, the daily maintenance plan for the plant may be output; when the diagnosis result involves the disease or cause of disease of the plant, the treatment maintenance plan for the plant may be output, and optionally, complementary daily maintenance plans and preventive maintenance plans may also be output.

For illustrative purposes, a non-limiting example application of the method 100 may include the disease diagnosis of a tomato plant maintained by a user. In this example, the tomato plant in the plant image input by the user has some leaves with mold, and there are obstacles hindering the ventilation of the tomato plant. To further help the user maintain the tomato, a maintenance task “It is recommended to cut off the leaves infected with mold and move the plant to a more ventilated location to avoid continued molding” may be generated according to the diagnosis result “Cause of disease: poor ventilation”.

After generating the maintenance task according to the diagnosis result, since the database also stores the identification of maintenance apparatus that is communicatively coupled with the user terminal, the identification of maintenance apparatus associated with the maintenance task may also be determined from the database according to the maintenance task, thereby generating a maintenance plan. After obtaining the maintenance plan, the maintenance plan may be displayed on the user interface. Thus, the user is able to know what kind of maintenance apparatus (such as irrigation apparatus, fertilization apparatus, moving apparatus, pruning apparatus, medication apparatus, illumination control apparatus, temperature control apparatus, humidity control apparatus, etc., or combinations thereof) should be used and what kind of maintenance tasks should be implemented to maintain the tomato. Maintenance tasks may include, for example, watering, spraying water, fertilizing, pruning, weeding, pot rotation, moving, sunlight exposure, shading, adjusting temperature, adjusting humidity, applying pesticides, and applying fungicides, etc. Specifically, the maintenance task may also include various parameters of the task, such as watering time, interval, amount of water, fertilizer dosage, time, interval, pruning position, pesticide spraying dosage and position, target position for movement, etc.

In some embodiments, the method 100 may include: controlling corresponding maintenance apparatus according to the identification of the maintenance apparatus in each pair of the one or more pairs in the maintenance plan to complete the one or more maintenance tasks in the pair.

Since the maintenance apparatus typically have communication functions, commands may be transmitted to the maintenance apparatus (for example, via Bluetooth protocol, Zigbee protocol, etc.). For example, in the aforementioned example, the maintenance plan may include two pairs: {leaf pruning task, identification of pruning apparatus} and {plant moving task, identification of moving apparatus}. According to the identification, commands indicating the execution of pruning tasks and moving tasks are sent to the corresponding pruning apparatus and moving apparatus respectively, thereby controlling the pruning apparatus and moving apparatus to automatically complete the pruning tasks and moving tasks, thus reducing the user's maintenance burden and improving maintenance efficiency.

In addition to automatically executing the maintenance plan, in some embodiments, after displaying the maintenance plan, the user may be further asked whether to confirm the execution of the maintenance plan, and after the user confirms the execution of the maintenance plan, the corresponding maintenance apparatus may be controlled according to the maintenance plan to complete the corresponding maintenance tasks.

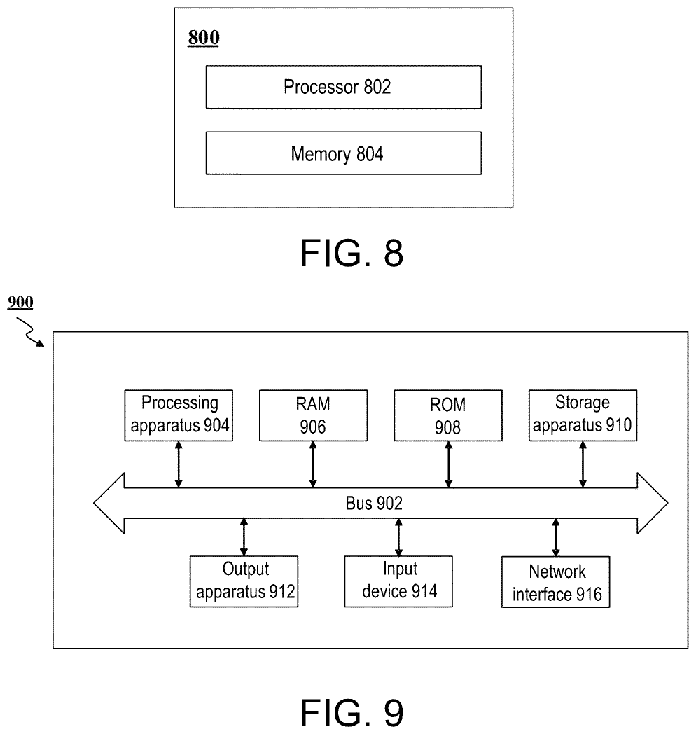

The present disclosure in another aspect also provides an electronic device. Referring to FIG. 8, which shows a schematic block diagram of an electronic device 800 according to some embodiments of the present disclosure. As shown in FIG. 8, the electronic device 800 includes a processor 802 and a memory 804 storing computer-executable instructions which, when being executed by the processor 802, cause the processor 802 to execute the plant diagnosis method according to any of the aforementioned embodiments of the present disclosure. The processor 802 may be, for example, a central processing unit (CPU) of the electronic device 800. The processor 802 may be any type of general-purpose processor, or may be a processor specifically designed for plant diagnosis, such as an application-specific integrated circuit (ASIC). The memory 804 may be coupled to the processor 802, and may include various computer-readable media accessible by the processor 802. In various embodiments, the memory 804 described herein may include volatile and non-volatile media, removable and non-removable media. For example, the memory 804 may include any combination of: random access memory (RAM), dynamic RAM (DRAM), static RAM (SRAM), read-only memory (ROM), flash memory, cache memory and/or any other type of non-transitory computer-readable media. The memory 804 may store instructions which, when being executed by the processor 802, cause the processor 802 to execute the method 100 according to any of the aforementioned embodiments of the present disclosure.

In some embodiments, the electronic device 800 may be implemented as a smartphone, smart tablet, smart camera, computer, etc.

The electronic device 800 is configured to execute the method 100 according to any of the aforementioned embodiments, therefore reference may be made to the previous descriptions of various embodiments of the method 100, which will not be repeated here.

The present disclosure also provides a non-transitory storage medium storing computer-executable instructions which, when being executed by a computer, cause the computer to execute the plant diagnosis method according to any of the aforementioned embodiments of the present disclosure.

The present disclosure also provides a computer program product, which may include instructions that, when being executed by a processor, may implement the plant diagnosis method according to any of the aforementioned embodiments of the present disclosure. The instructions may be any instruction set that will be executed directly by one or more processors, such as machine code, or any instruction set that will be executed indirectly, such as scripts. The instructions may be stored in object code format for direct processing by one or more processors, or stored as any other computer language, including scripts or collections of independent source code modules that are interpreted on demand or compiled in advance.

FIG. 9 shows a schematic block diagram of a computer system 900 on which embodiments of the present disclosure may be implemented. The computer system 900 includes a bus 902 or other communication mechanism for transmitting information, and a processing apparatus 904 coupled with the bus 902 for processing information. The computer system 900 also includes a memory 906 coupled to the bus 902 for storing instructions to be executed by the processing apparatus 904, and the memory 906 may be a random access memory (RAM) or other dynamic storage apparatus. The memory 906 may also be used to store temporary variables or other intermediate information during execution of instructions by the processing apparatus 904. The computer system 900 also includes a read only memory (ROM) 908 or other static storage apparatus coupled to the bus 902 for storing static information and instructions for the processing apparatus 904. A storage apparatus 910, such as a magnetic disk or optical disk, is provided and coupled to the bus 902 for storing information and instructions. The computer system 900 may be coupled to the output apparatus 912 through the bus 902 for providing output to a user, for example but not limited to displays (such as a cathode ray tube (CRT) or liquid crystal display (LCD)), speakers, etc. An input device 914, such as a keyboard, mouse, microphone, etc., is coupled to the bus 902 for communicating information and command selections to the processing apparatus 904. The computer system 900 may execute embodiments of the present disclosure. Consistent with some implementations of the present disclosure, results are provided by the computer system 900 in response to the processing apparatus 904 executing one or more sequences of one or more instructions contained in the memory 906. Such instructions may be read into the memory 906 from another computer-readable medium, such as the storage apparatus 910. Execution of the sequences of instruction sequences contained in the memory 906 causes the processing apparatus 904 to perform the methods described herein. Alternatively, hardwired circuitry may be used in place of or in combination with software instructions to implement the teachings. Thus, implementations of the present disclosure are not limited to any specific combination of hardware circuitry and software. In various embodiments, the computer system 900 may be connected to one or more other computer systems like the computer system 900 through a network interface 916 across a network to form a networked system. The network may include a private network or a public network such as the Internet. In a networked system, one or more computer systems may store data and provide the data to other computer systems. As used herein, the term “computer-readable medium” refers to any medium that participates in providing instructions to the processing apparatus 904 for execution. Such a medium may take many forms, including but not limited to, non-volatile media, volatile media, and transmission media. Non-volatile media includes, for example, optical or magnetic disks, such as the storage apparatus 910. Volatile media includes dynamic memory, such as the memory 906. The transmission media includes coaxial cables, copper wire and fiber optics, including the wires that include the bus 902. Common forms of computer-readable media or computer program products include, for example, a floppy disk, a flexible disk, hard disk, magnetic tape, or any other magnetic medium, a CD-ROM, digital video disk (DVD), Blu-ray disk, any other optical medium, thumb drive, memory card, RAM, PROM and EPROM (erasable programmable read-only memory), flash EPROM, any other memory chip or cartridge, or any other tangible medium from which a computer can read. Various forms of computer-readable media may be involved in carrying one or more sequences of one or more instructions to the processing apparatus 904 for execution. For example, the instructions may initially be carried on a magnetic disk of a remote computer. The remote computer may load the instructions into its dynamic memory and send the instructions over a telephone line using a modem. A modem local to the computer system 900 may receive the data on the telephone line and use an infrared transmitter to convert the data to an infrared signal. An infrared detector coupled to the bus 902 may receive the data carried in the infrared signal and place the data on the bus 902. The bus 902 carries the data to the memory 906, from which the processing apparatus 904 retrieves and executes the instructions. For example, the instructions received by the memory 906 may be stored on the storage apparatus 910 either before or after execution by the processing apparatus 904.

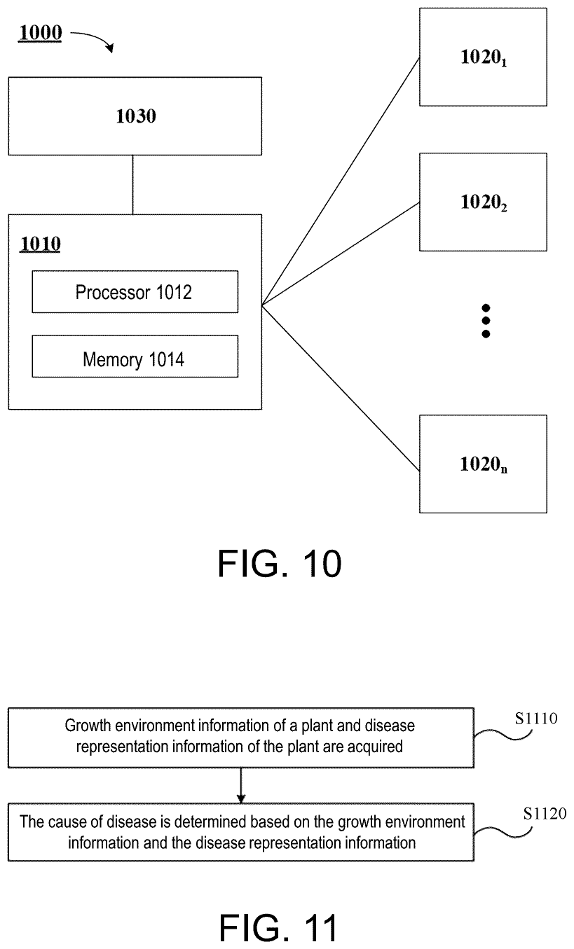

FIG. 10 shows a schematic block diagram of a maintenance system 1000 according to some embodiments of the present disclosure. The maintenance system 1000 includes an electronic device 1010, which includes a processor 1012 and a memory 1014 coupled to the processor 1012 and storing instructions. The electronic device 1010 may take the form of, but not limited to, the aforementioned electronic device 800 or computer system 900, etc., and may be implemented as, for example but not limited to, a smartphone, smart tablet, smart camera, computer, etc. The memory 1014 may store instructions that, when being executed by the processor 1012, enable the processor 1012 to execute the plant diagnosis method according to any of the aforementioned embodiments of the present disclosure. The maintenance system 1000 also includes (one or more) maintenance apparatuses (e.g., 1020₁, 1020₂, . . . , 1020ₙ) communicatively coupled to the electronic device 1010, which are configured to execute maintenance tasks in response to receiving the commands from the electronic device 1010.

Specifically, in some embodiments, the instructions stored in the memory 1014, when being executed by the processor 1012, may enable the processor 1012 to: acquire information related to a plant based on a user input, the information including one or more plant images; input the information into a plant diagnosis model, the plant diagnosis model including at least one of a first identification model and a second identification model, the first identification model being configured to acquire growth environment information of the plant based on the information, the second identification model being configured to acquire disease representation information of the plant based on the information, wherein the first identification model and the second identification model are respectively trained using sample-labeled data containing multiple modalities, the multiple modalities include images; output, through the plant diagnosis model, a diagnosis result of the plant determined based on the growth environment information and disease representation information of the plant; generate a maintenance plan according to the diagnosis result, the maintenance plan including one or more pairs, each pair of the one or more pairs including one or more maintenance tasks and identification of a maintenance apparatus for executing the one or more maintenance tasks; and transmit commands to a corresponding maintenance apparatus according to the identification of the maintenance apparatus in each pair of the one or more pairs in the maintenance plan to control the corresponding maintenance apparatus to complete the one or more maintenance tasks in the pair.

In some embodiments, the electronic device 1010 includes a user interface (not shown). For example, the diagnosis result may be displayed on the user interface, and/or the maintenance plan may be displayed on the user interface.

In some embodiments, the maintenance system 1000 may include a camera 1030 communicatively coupled to the electronic device 1010. The camera 1030 may be any suitable imaging device for monitoring a target plant. The target plant may be positioned in the field of view of the camera 1030. The camera 1030 may be configured to capture plant images and transmit the captured plant images to the electronic device 1010. For example, capturing plant images may be realized through capturing photos or taking videos. Accordingly, the instructions stored in the memory 1014 may include instructions that, when being executed by the processor 1012, enable the processor 1012 to perform operations of: outputting a diagnosis result based on plant images received from the camera 1030.

In some embodiments, the plant images received from the camera 1030 may be input into the aforementioned plant diagnosis model for processing, and a maintenance plan may be generated according to the diagnosis result output based on the plant images received from the camera 1030. The maintenance plan includes one or more pairs, each pair of the one or more pairs includes one or more maintenance tasks and identification of a maintenance apparatus for executing the one or more maintenance tasks. Commands may be transmitted to the corresponding maintenance apparatus according to the identification of the maintenance apparatus in each pair of the one or more pairs in the maintenance plan to control the corresponding maintenance apparatus to complete the one or more maintenance tasks in the pair.

For example, in situations where close-up images or videos of one or more feature parts of the target plant are required, it may not be necessary for the user to input these close-up images or videos, but instead the camera 1030 may automatically acquire these close-up images or videos. Alternatively, when plant images from the user cannot be diagnosed due to various reasons such as lack of clarity or not including the diseased parts, it may not be necessary for the user to re-input plant images, but instead the camera 1030 may automatically acquire plant images. That is to say, plant images captured by the camera 1030 may be used to assist in generating the diagnosis result.

Accordingly, images captured by the camera 1030 may be used to autonomously generate diagnosis results, and automatically execute the maintenance plan in order to realize fully automated monitoring and maintenance of the target plant.

Various embodiments of the maintenance system 1000 may be similar to any embodiments of the aforementioned aspects of the present disclosure, which will not be elaborated here.

FIG. 11 is a flow diagram of a plant diagnosis method according to some embodiments of the present disclosure. The method may be executed by an application program installed on an electronic device such as a computer, mobile phone, and so on to provide plant diagnosis functions to a user. The method may include steps S1110 and S1120 as described below.

In step S1110, growth environment information of a plant and disease representation information of the plant are acquired. Here, the disease representation information includes the appearance exhibited by the plant due to the disease. In step S1120, the cause of disease is determined based on the growth environment information of the plant and the disease representation information of the plant.

For example, when the growth environment information of the plant indicates poor illumination and normal soil moisture, and the disease representation information of the plant indicates that the plant is excessively elongated and weak, it may be determined that the cause of disease is lack of illumination. How to determine the cause of disease will be further introduced in combination with some embodiments in the following text.

In the above embodiment, the cause of disease is determined according to both the growth environment information of the plant and the disease representation information of the plant, which may be adopted to accurately determine the cause of disease, and is beneficial for subsequent treatment or maintenance of the plant according to the cause of disease, thus improving the processing effect of plant diseases.

As some implementations, the plant diagnosis method shown in FIG. 11 may be realized by an application program on a user's terminal. The terminal includes, for example, a mobile phone, a tablet computer, a laptop computer, etc. The terminal may include, for example, a display, which may be configured to show one or more user interfaces of the application program to the user, with which the user may interact.

In some embodiments, acquiring growth environment information or acquiring disease representation information includes: directly acquiring from the user through human-computer interaction method and/or acquiring from images input by the user through computer vision technology.

Here, directly acquiring from the user through human-computer interaction method refers to that the information acquired from the user may directly indicate growth environment information and/or disease representation information, for example, text information such as “good illumination” and “excessively elongated and weak” may be acquired from the user. Through computer vision technology, growth environment information and/or disease representation feature cannot be directly acquired from images input by the user, but require analysis and processing of the images before obtaining growth environment information and/or disease representation information. The two methods of human-computer interaction and computer vision technology will be further introduced in combination with some embodiments in the following text.

It should be understood that growth environment information and disease representation information may be acquired only directly from the user through human-computer interaction method, or may be acquired only from images input by the user through computer vision technology, or may be acquired through a combination of both human-computer interaction and computer vision technology. For example, nutrition environment information is not easily acquired through computer vision technology, while illumination environment information is easily acquired through computer vision technology, therefore both human-computer interaction and computer vision technology may be combined to acquire nutrition environment information and illumination environment information. In another example, a specific item of growth environment information or disease representation information may be first acquired through computer vision technology, and then modified content or more accurate content for this information or feature may be acquired from the user through human-computer interaction method.

In the above embodiment, acquiring growth environment information or acquiring disease representation information may be realized through human-computer interaction and/or computer vision technology. Accordingly, the user may choose between human-computer interaction and/or providing images according to their own situation, which is beneficial for improving the user's experience.

The following introduces how to acquire the growth environment information of the plant and/or the disease representation information of the plant from images input by the user through computer vision technology.

The labeled sample images may be trained to acquire a first identification model. The first identification model may be a neural network model, such as a convolutional neural network model or a residual network model, which is beneficial for improving the recognition accuracy and efficiency of growth environment information, thereby improving the accuracy and efficiency of determining the cause of disease.

As some implementations, disease representation information may be identified based on images and a pre-trained second identification model. The second identification model may be a neural network model, such as a convolutional neural network model or a residual network model, which is beneficial for improving the recognition accuracy and efficiency of disease representation information, thereby improving the accuracy and efficiency of determining the cause of disease.

As some implementations, an interactive questionnaire related to the growth environment information of the plant and/or the disease representation information of the plant may be displayed to the user, and the growth environment information of the plant and/or the disease representation information of the plant may be determined through the user's input. The interactive questionnaire may be in a question-and-answer format, for example, the user may be asked “How is the light intensity?”, and the illumination environment information may be acquired as good illumination through the user's text response (for example, good illumination). The interactive questionnaire may also be in a selection format, in response to the user's selection operation, the growth environment information of the plant and/or the disease representation information of the plant may be acquired. For example, the user may be asked “How is the light intensity?”, and 3 options of “good illumination”, “poor illumination” and “others” may be displayed to the user, in response to the user's selection of “good illumination”, the illumination environment information may be determined as good illumination.

In some embodiments, the growth environment information of the plant and/or the disease representation information of the plant may be identified based on received images through computer vision technology, then supplementary information associated with the plant may be directly acquired from the user through human-computer interaction method, and the cause of the disease may be determined based on the growth environment information, disease representation information and supplementary information. In these embodiments, combining the identification of growth environment information and disease representation information through computer vision technology with acquiring supplementary information through human-computer interaction method helps to more accurately determine the growth environment information and disease representation information, and/or to more accurately determine the cause of the disease.

As some implementations, the supplementary information may include one or more of the following: supplementary information about the growth environment of the plant, supplementary information about the disease representation information of the plant, supplementary information about the maintenance method of the plant, supplementary information about the density situation of the plant, supplementary information about the growth location of the plant, or supplementary information about the time associated with the plant being diagnosed. Here, the supplementary information about the maintenance method of the plant, the supplementary information about the density situation of the plant, the supplementary information about the growth location of the plant, and the supplementary information about the time associated with the plant being diagnosed may refer to the introduction of the density situation of the plant, the growth location of the plant, the time associated with the plant being diagnosed, and the maintenance method of the plant mentioned above, which will not be repeated here.

For example, the illumination environment information of the plant may be identified through computer vision technology, and then combined with supplementary information about illumination to determine whether the illumination environment information identified by computer vision technology is accurate. If it is not accurate, the illumination environment information may be identified again, or supplementary information about illumination may be acquired from the user again, or the identified illumination environment information of the plant may be corrected according to the supplementary information about illumination. The same environment information and/or disease representation information may be acquired through computer vision technology and supplementary information acquired through human-computer interaction method, which is conducive to improving the accuracy of the acquired growth environment information and/or disease representation information, thereby improving the accuracy of determining the cause of disease.

In another example, the illumination environment information of the plant and the disease representation information of the plant may be identified according to computer vision technology, and then information not identified by computer vision technology may be acquired through the human-computer interaction method, such as supplementary information about the density situation of the plant, and finally the cause of disease may be determined by combining the information acquired through the two methods. In this way, the information used to determine the cause of disease is more abundant, and the determination of the cause of disease is more accurate.

In some embodiments, corresponding treatment plan and/or maintenance plan may be determined based on the cause of disease, and the treatment plan and/or maintenance plan may be output to the user. In this way, the user may treat and/or maintain the plant according to the treatment plan and/or maintenance plan, which helps the user to timely solve the plant disease and improve user experience.

As some implementation methods, treatment plan may be determined based on the cause of disease. For example, when the disease representation information is leaf mold spots, leaf yellowing or leaf spots or marks, and the growth environment information indicates that the ventilation degree at the root of the plant is poor, the cause of disease may be determined as bacterial infection. Since bacterial infection is related to poor soil permeability, the treatment plan may be determined as loosening the soil, applying systemic fungicide to the soil, cutting off the leaves infected by bacteria, and placing the plant in a well-ventilated position. In addition, since leaf marks may be related to red spiders, the treatment plan may also include spraying acaricide.

For example, when the disease representation information is moldy young fruit, and the growth environment information indicates that the ventilation degree of the plant body is poor, the cause of disease may be determined as poor ventilation. Therefore, the treatment plan may be placing the plant in a well-ventilated position, removing the overly dense leaves at the lower part (about 10 leaves) to expose the young fruit, and promptly cutting off the moldy parts. For example, when the disease representation information is some withered branches at the base of the plant, and the growth environment information indicates excessive illumination, the cause of disease may be determined as excessive illumination. Since excessive illumination causes dwarfing of the plant, making the plant body poorly ventilated. Therefore, the treatment plan may be determined as placing the plant in a place with relatively weak sunlight and higher humidity.

As some implementation methods, maintenance plan may be determined based on the cause of disease. For example, when the cause of disease is determined to be soil compaction, the maintenance plan may be determined as regularly loosening the soil, and regularly supplementing fertilizer containing iron elements. For example, notifications for soil loosening and fertilizing may be regularly pushed to the user through an application program. As some implementation methods, the original maintenance plan may be adjusted based on the cause of disease to generate a new maintenance plan. For example, if the original maintenance plan is to water the plant once every 10 days, when the cause of disease is determined to be insufficient watering, the maintenance plan may be determined as watering the plant once every 5 days.

In some embodiments, after determining the cause of disease, information associated with the disease representation information and/or the cause of disease may also be output to the user. For example, information associated with the disease representation information may be typical images of the disease representation information and/or detailed text description of the disease representation information. Information associated with the cause of disease may be an introduction to how the cause of disease leads to the disease representation information. By outputting information associated with the disease representation information and/or the cause of disease to the user, the user's need to understand the disease representation information and/or the cause of disease may be satisfied, thereby improving user experience.

FIG. 12 is a flow diagram of a plant diagnosis method according to some embodiments of the present disclosure. The method may be executed by an application program installed on electronic devices such as a computer, a mobile phone, and so on to provide plant diagnosis function to the user. The method may include steps S1210 and S1240 as described below.

As shown in FIG. 12, in step S1210, an image of a plant is acquired. In step S1220, based on the image, whether the plant has a disease is identified through computer vision technology. As some implementation methods, in the situation where the plant is identified as not having a disease, information of “the plant does not have a disease” may be displayed to the user. As some implementation methods, information such as the category of the plant may also be identified through computer vision technology, and information such as the category of the plant and whether the plant has a disease may be informed to the user together.

In step S1230, in response to identifying that the plant has a disease, the user is prompted to input additional images of the plant. Here, the additional images are associated with the growth environment of the plant and/or associated with the parts of the plant that have diseases. As some implementation methods, capturing prompts may be determined according to the identified plant disease, and the capturing prompts may be displayed to the user to guide the user to input additional images of the plant. The content and form of the capturing prompts may refer to the introduction of FIG. 12 and FIG. 13 above.

In step S1240, at least based on the additional images, the cause of the disease is determined. As some implementation methods, the cause of the disease may be determined solely based on the additional images. As some other implementation methods, the cause of the disease may be determined based on the image used for identifying whether the plant has a disease and the additional images. As some implementation methods, the method shown in FIG. 11 may be referred to, where growth environment information and/or disease representation information are identified according to the image, thereby determining the cause of disease. As some other implementation methods, the method shown in FIG. 6 may be referred to, where the image is sent to an expert, so that the expert is able to determine the cause of disease. As yet some other implementation methods, a cause identification model may be pre-trained, and the cause of disease may be determined based on the image and the cause identification model.

In the above embodiments, after acquiring the plant image, it may be determined whether the plant has a disease, and in the situation where the plant has a disease, the cause of the disease may be determined. This is beneficial for the user to understand the health condition of the plant, and in the situation where the plant has a disease, to understand the cause of the disease, facilitating subsequent targeted treatment.

Each embodiment in this specification is described in a progressive manner, with each embodiment focusing on the differences from other embodiments, and the same or similar parts between various embodiments may be cross-referenced. For the apparatus embodiments, since they basically correspond to the method embodiments, the descriptions are relatively simple, and the relevant parts may refer to the partial descriptions of the method embodiments.

FIG. 13 is a structural diagram of a plant diagnosis apparatus according to some embodiments of the present disclosure. As shown in FIG. 13, the plant diagnosis apparatus 600 includes an acquisition module 610 and a determination module 620. The acquisition module 610 is configured to acquire growth environment information of a plant and disease representation information of the plant. Here, the disease representation information includes the appearance exhibited by the plant due to the disease. The determination module 620 is configured to determine the cause of disease based on the growth environment information and the disease representation information.

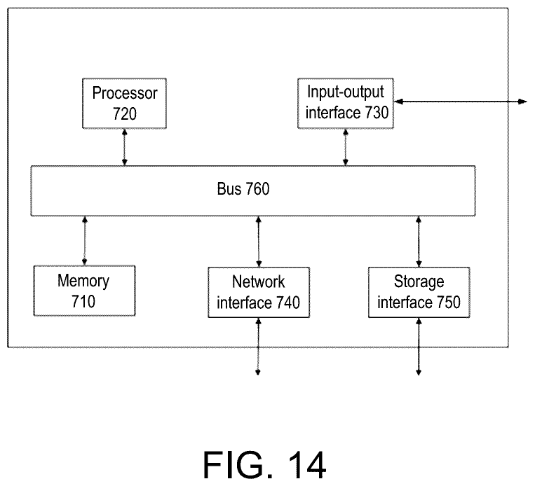

FIG. 14 is a structural diagram of a plant diagnosis apparatus according to some other embodiments of the present disclosure. As shown in FIG. 14, the plant diagnosis apparatus 700 includes a memory 710 and a processor 720 coupled to the memory 710. The processor 720 is configured to execute the method of any one of the aforementioned embodiments based on instructions stored in the memory 710.

The memory 710 may include, for example, system memory, fixed non-volatile storage media, etc. The system memory may store, for example, operating systems, application programs, boot loader, and other programs, etc.

The plant diagnosis apparatus 700 may also include an input-output interface 730, a network interface 740, a storage interface 750, etc. These interfaces 730, 740, 750, as well as the memory 710 and the processor 720, may be connected through a bus 760, for example. The input-output interface 730 provides connection interfaces for display, mouse, keyboard, touch screen, and other input-output devices. The network interface 740 provides connection interfaces for various networked devices. The storage interface 750 provides connection interfaces for external storage devices such as SD (secure digital) cards, USB (universal serial bus) flash drives, etc.

The systems, apparatus, modules or units described in the above embodiments may be specifically implemented by computer chips or entities, or by products with specific functions. A typical implementation device is a server system. Of course, this disclosure does not exclude that, with the future development of computer technology, the computer implementing the functions of the above embodiments may be, for example, a personal computer, a laptop computer, a vehicle-mounted human-machine interaction device, a cellular telephone, a camera phone, a smartphone, a personal digital assistant, a media player, a game console, a tablet computer, a wearable device, or any combination thereof.

For convenience of description, the above apparatus are described separately as various modules by functions. Of course, when implementing one or more embodiments of the present disclosure, the functions of each module may be implemented in one or more software and/or hardware, or modules implementing the same function may be implemented by a combination of multiple sub-modules or sub-units, etc. The apparatus embodiments described above are merely illustrative. For example, the division of the units is only a logical functional division, and there may be other division methods in actual implementation. For example, multiple units or components may be combined or integrated into another system, or some features may be ignored or not executed. Another point is that the coupling or direct coupling or communication connection shown or discussed between one another may be carried out through some interfaces, and indirect coupling or communication connection between apparatuses or units may be in electrical, mechanical or other forms.

The present disclosure is described with reference to flowcharts and/or block diagrams of methods, apparatus (systems), and computer program products according to embodiments of the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, a special-purpose computer, an embedded processor, or other programmable data processing apparatus to produce a machine, such that the instructions executed by the processor of the computer or other programmable data processing apparatus produce an apparatus for implementing the functions specified in one or more processes in the flowchart and/or one or more blocks in the block diagram.

These computer program instructions may also be stored in a computer-readable memory that can direct a computer or other programmable data processing apparatus to work in a specific method, such that the instructions stored in the computer-readable memory produce a manufactured product including an instruction apparatus, which implements the functions specified in one or more processes in the flowchart and/or one or more blocks in the block diagram. These computer program instructions may also be loaded onto a computer or other programmable data processing devices, such that a series of operation steps are performed on the computer or other programmable devices to produce a computer-implemented process, thereby providing steps for implementing the functions specified in one or more processes in the flowchart and/or one or more blocks in the block diagram by the instructions executed on the computer or other programmable devices.

Those skilled in the art should understand that one or more embodiments of the present disclosure may take the form of entirely hardware embodiments, entirely software embodiments, or embodiments combining software and hardware aspects. Moreover, one or more embodiments of the present disclosure may take the form of a computer program product implemented on one or more computer-usable storage media (including but not limited to magnetic disk storage, CD-ROM, optical storage, etc.) containing computer-usable program code.

One or more embodiments of the present disclosure may be described in the general context of computer-executable instructions executed by a computer, such as program modules. Generally, program modules include routines, programs, objects, components, data structures, and so on that perform particular tasks or implement particular abstract data types. One or more embodiments of the present disclosure may also be practiced in distributed computing environments, where tasks are performed by remote processing devices that are connected through a communications network. In a distributed computing environment, program modules may be located in both local and remote computer storage media including a storage device.

The above description is merely an embodiment of one or more embodiments of the present disclosure, and is not intended to limit one or more embodiments of the present disclosure. For those skilled in the art, one or more embodiments of the present disclosure may have various changes and variations. Any modifications, equivalent replacements, improvements, and so on made within the spirit and principles of the present disclosure should be included within the scope of the claims.

What is claimed is:

1. A plant diagnosis method, comprising:
acquiring information related to a plant based on a user input, the information comprising one or more plant images;
inputting the information into a plant diagnosis model, the plant diagnosis model comprising at least one of a first identification model and a second identification model, the first identification model being configured to acquire growth environment information of the plant based on the information, the second identification model being configured to acquire disease representation information of the plant based on the information, wherein the first identification model and the second identification model are respectively trained using sample-labeled data containing multiple modalities, the multiple modalities comprising images; and
outputting a diagnosis result of the plant determined based on the growth environment information and the disease representation information of the plant through the plant diagnosis model.

2. The plant diagnosis method according to claim 1, wherein the information further comprises one or more plant texts related to at least one of an environment and a disease of the plant in the one or more plant images.

3. The plant diagnosis method according to claim 2, wherein
the first identification model comprises a first image processing model capable of processing the one or more plant images and trained using a first subset of first training data and a first text processing model capable of processing the one or more plant text and trained using a second subset of the first training data, the first subset of the first training data comprises sample plant images and the growth environment information labeled for the sample plant images, the second subset of the first training data comprises sample plant text and the growth environment information labeled for the sample plant text;
the second identification model comprises a second image processing model capable of processing the one or more plant images and trained using a first subset of second training data and a second text processing model capable of processing the one or more plant text and trained using a second subset of the second training data, the first subset of the second training data comprises sample plant images and the disease representation information labeled for the sample plant images, the second subset of the second training data comprises sample plant text and the disease representation information labeled for the sample plant images.

4. The plant diagnosis method according to claim 3, wherein
at least one image processing model of the first image processing model and the second image processing model is a multimodal model capable of processing the images; and/or
at least one text processing model of the first text processing model and the second text processing model is a multimodal model capable of processing text.

5. The plant diagnosis method according to claim 2, wherein
the first identification model comprises a first multimodal model capable of processing the one or more plant images and the one or more plant texts, the first multimodal model is trained using first multimodal data, the first multimodal data comprises both sample plant images and sample plant texts as well as the growth environment information labeled for the sample plant images and the sample plant texts; and
the second identification model comprises a second multimodal model capable of processing the one or more plant images and the one or more plant texts, the second multimodal model is trained using second multimodal data, the second multimodal data comprises both the sample plant images and the sample plant texts as well as the disease representation information labeled for the sample plant images and the sample plant texts.

6. The plant diagnosis method according to claim 5, wherein
the first multimodal model comprises a first visual model and a first multimodal large language model, the first visual model is configured to receive a first plant image from the one or more plant images to extract first image features of the first plant image, the first multimodal large language model is configured to receive the first image features and a first plant text from the one or more plant texts to extract the growth environment information;
the second multimodal model comprises a second visual model and a second multimodal large language model, the second visual model is configured to receive a second plant image from the one or more plant images to extract second image features of the second plant image, the second multimodal large language model is configured to receive the second image features and a second plant text from the one or more plant texts to extract the disease representation information.

7. The plant diagnosis method according to claim 1, wherein:
in a situation where the plant diagnosis model does not comprise the first identification model, the information comprises the growth environment information of the plant; and/or
in a situation where the plant diagnosis model does not comprise the second identification model, the information comprises the disease representation information of the plant.

8. The plant diagnosis method according to claim 1, wherein the growth environment information comprises one or more of illumination environment information, humidity environment information, air environment information, temperature, soil moisture information, soil particle information and soil health of a growth environment of the plant.

9. The plant diagnosis method according to claim 1, wherein
the disease representation information comprises one or more of leaf spots, brown spots, excessive elongation and weakness, basal soft rot, flowering lodging, stem softening and lodging, leaf mold spots, mold on young fruits, leaf yellowing and withering, and insect bite damage.

10. The plant diagnosis method according to claim 1, wherein the diagnosis result comprises a cause of a disease of the plant, the cause of the disease comprises one or more of lack of illumination, excessive illumination, lack of watering, excessive watering, poor ventilation, excessively high temperature, excessively low temperature, overly dry soil, overly wet soil, soil compaction, oversized soil particles, lack of pruning, lack of fertilizer, pathogen infection, pest and disease, soil salinization, and root rot.

11. The plant diagnosis method according to claim 1, wherein the information further comprises other information of the plant, the other information comprises one or more of a density situation of the plant, a growing location of the plant, a time associated with the plant being diagnosed, and a maintenance method of the plant, and
wherein outputting the diagnosis result of the plant determined based on the growth environment information and the disease representation information of the plant through the plant diagnosis model comprises outputting the diagnosis result of the plant determined based on the growth environment information, the disease representation information and the other information of the plant through the plant diagnosis model.

12. The plant diagnosis method according to claim 1, wherein the outputting the diagnosis result of the plant determined based on the growth environment information and the disease representation information of the plant through the plant diagnosis model comprises:
determining a cause of a disease of the plant corresponding to the growth environment information and the disease representation information of the plant based on a correspondence relationship between the growth environment information, the disease representation information and the cause of the disease of the plant pre-stored in a database; and
placing at least one of the determined cause of the disease and a processing method for the determined cause of the disease in the diagnosis result of the plant.

13. The plant diagnosis method according to claim 12, wherein the processing method comprises at least one of a treatment method for the disease and maintenance suggestions for the plant.

14. The plant diagnosis method according to claim 1, wherein the one or more plant images comprises at least one of:
a plant image that is able to present an overall appearance of the plant;
a plant image that is able to present an appearance of a diseased part of the plant; and
a plant image that is able to present a growth environment of the plant.

15. The plant diagnosis method according to claim 1, comprising:
before the user input, displaying a prompt to a user to guide the user to capture or describe a plant body and/or a growth environment of the plant.

16. The plant diagnosis method according to claim 1, comprising:
in a situation where the diagnosis result of the plant cannot be determined based on the growth environment information and disease representation information of the plant, which are acquired currently, displaying interactive questions to a user about identifying at least one of the growth environment information and the disease representation information of the plant; and
acquiring a response to the interactive questions from the user, and inputting the response into the plant diagnosis model, to output the diagnosis result of the plant determined based on the growth environment information and the disease representation information of the plant and the response through the plant diagnosis model.

17. The plant diagnosis method according to claim 16, wherein the interactive questions comprise requesting one or more of close-up images of one or more diseased parts or a growth environment of the plant, a capturing time of the one or more plant images, a capturing location of the one or more plant images.

18. The plant diagnosis method according to claim 1, comprising:
generating a maintenance plan according to the diagnosis result, the maintenance plan comprising one or more pairs, each pair of the one or more pairs comprising one or more maintenance tasks and identification of a maintenance apparatus for executing the one or more maintenance tasks;
outputting the maintenance plan.

19. The plant diagnosis method according to claim 18, comprising:
controlling a corresponding maintenance apparatus according to the identification of the maintenance apparatus in the each pair of the one or more pairs in the maintenance plan to complete the one or more maintenance tasks in the pair.

20. An electronic device, comprising:
a processor; and
a memory storing computer-executable instructions, wherein the computer-executable instructions, when being executed by the processor, enable the processor to execute the plant diagnosis method according to claim 1.

21. A non-transitory storage medium storing computer-executable instructions, wherein the computer-executable instructions, when being executed by a computer, enable the computer to execute the plant diagnosis method according to claim 1.

22. A computer program product, wherein the computer program product comprises instructions, and the instructions, when being executed by a processor, realize the plant diagnosis method according to claim 1.

23. A maintenance system, comprising:
an electronic device, comprising a processor and a memory coupled to the processor and storing instructions, wherein the instructions, when being executed by the processor, enable the processor to:
acquire information related to a plant based on a user input, the information comprising one or more plant images;
input the information into a plant diagnosis model, the plant diagnosis model comprising at least one of a first identification model and a second identification model, the first identification model being configured to acquire growth environment information of the plant based on the information, the second identification model being configured to acquire disease representation information of the plant based on the information, wherein the first identification model and the second identification model are respectively trained using sample-labeled data containing multiple modalities, the multiple modalities comprising images;
output a diagnosis result of the plant determined based on the growth environment information and the disease representation information of the plant through the plant diagnosis model,
generate a maintenance plan according to the diagnosis result, the maintenance plan comprising one or more pairs, each pair of the one or more pairs comprising one or more maintenance tasks and identification of a maintenance apparatus for executing the one or more maintenance tasks; and
transmit commands to a corresponding maintenance apparatus according to the identification of the maintenance apparatus in the each pair of the one or more pairs in the maintenance plan to control the corresponding maintenance apparatus to complete the one or more maintenance tasks in the pair; and
a maintenance apparatus communicatively coupled to the electronic device, wherein the maintenance apparatus is configured to execute the one or more maintenance tasks in response to receiving the commands from the electronic device.

24. The maintenance system according to claim 23, comprising:
a camera communicatively coupled to the electronic device, wherein the camera is configured to capture plant images and transmit the captured plant images to the electronic device,
wherein the instructions comprise instructions that, when being executed by the processor, enable the processor to execute following operation:
outputting the diagnosis result based on the plant images received from the camera.
